(19) United States
(12) Patent Application Publication
(10) Pub. No.: US 2017/0270930 A1
(43) Pub. Date: Sep. 21, 2017

(54) VOICE TALLYING SYSTEM

(71) Applicant: FLAGLER LLC, Flagler Beach, FL (US)

(72) Inventors: Erol James Ozmeral, Tampa, FL (US); Cenan Ozmeral, Flagler Beach, FL (US)

(21) Appl. No.: 15/500,198

(22) PCT Filed: Aug. 4, 2015
(86) PCT No.: PCT/US2015/043655

§ 371 Date: Jan. 30, 2017

Related U.S. Application Data
(60) Provisional application No. 62/032,699, filed on Aug. 4, 2014.

(51) Int. Cl. G10L 17/00; H04M 3/56; G06F 3/16; H04N 5/77; G10L 21/028; G10L 17/22

(52) U.S. Cl. CPC G10L 17/005; G10L 21/028; G10L 17/22; G06F 3/167; H04N 5/772; H04M 3/56; H04N 7/147

(57) ABSTRACT

The present invention relates to a voice tallying system to determine the relative participation of individual participants in a meeting. The voice tallying system according to the present invention comprises at least one voice recording device, a communication path from the voice recording device to a computing device having a voice analysis module. The voice tallying system and the method of the present invention include the capability to receive audio signals from each of the participants in a meeting and determine the identity of the speaker for each of the audio stream using voice profile information of the participants previously obtained and stored in the voice analysis module. The voice tallying system and the method further include the capability to tally the relative participation of a participant in a meeting in real time and as a result it is possible to display contemporaneously a voice tally for a participant with reference to that of other participants in the meeting.

### CROSS REFERENCE TO RELATED APPLICATION

This application claims the priority of the U.S. Provisional Application Ser. No. 62/032,699, filed on Aug. 4, 2014.

### FIELD OF THE INVENTION

This invention relates generally to conducting effective meetings. Using the voice tallying system and the method in accordance with the present invention, the participation of each participant in a meeting is monitored in real time and the relative participation of all participants in the meeting is displayed as a voice tally. The voice tallying system of the present invention is useful in meetings, teleconferences, videoconferences, training sessions, panel discussions and negotiations. Educational institutions, corporations, government agencies, non-governmental organization, public forums/panels and training companies will find the voice tallying system of the present invention useful in conducting effective meetings and in the subsequent training sessions.

### BACKGROUND OF THE INVENTION

During meetings, brain storming sessions, teleconferences, video conferences and training sessions the participation of individual participant varies greatly depending on each individual's personality, their knowledge of the topics as well as who else are participating in the meeting and who is moderating the meeting. Too often, very few people dominate meetings and others participate very little or not at all although participation by all participants is always desired and also required for best outcome of any meeting.

Each meeting has an objective and meeting requests are sent only to those people having expertise in the meeting topic with the expectation that they would actively participate and express their views on the topic for discussion and make appropriate recommendations. For example, the concept of brain storming introduced in the 1950s and widely practiced in the corporate environments is based on the assumption that the brain storming would produce more idea at a time than peoples working alone. In spite of this reasonable expectation, it is not hard to come across a business meeting where key people are not participating and not contributing to the meeting. Most of the times this problem goes unnoticed and even in those situations where the issues has become apparent, no measures are taken to rectify the situation as no remedy is readily available.

With the globalization of commerce, trading occurs across the borders and major corporations have become multinational corporations and have their presence in majority of the countries. Most of the time, the corporate meetings are conducted involving people located in several different countries through an audio or a video conference. In such corporate meetings, it is not uncommon for few key participants to remain quite for the entire meeting for reasons of language and cultural barriers. While the language barriers could be addressed by involving interpreters, the cultural barriers are difficult to overcome. In certain cultures the hierarchy within the organization is strictly followed and participants in a meeting who are at the lower rungs of the organization are quiet during the entire meeting and are hesitant to speak up in the meeting unless called upon. Most of the time these quiet participants go unnoticed and their valuable contribution to the meeting is totally lost.

Besides lack of knowledge of topic for discussion and the consciousness about their hierarchy among the participants in the meeting, individual's personality is a major factor holding an attendee of a meeting from active participation. This situation defeats the very purpose of brainstorming sessions organized in corporate environments to identify potential growth opportunity or to find a solution to an ongoing challenge. The person who is not actively involved in work-related discussions such as brainstorming or project team meetings is referred as an introvert. Introverts often feel uncomfortable in actively participating in a professional discussion even though they have a lot to contribute to the ongoing discussion or in identifying a solution to the problem in hand. One way to bring the introverts into active discussion and convert them as a valuable contributor in a professional discussion is to identify the introverts among the participants in a business meeting and provide them with a professional coach. At the other extreme, people who are extroverts, the opposite of introverts, often tend to dominate any professional discussions even though they have very little to contribute to the ongoing discussion. Therefore, in such a situation, there is also a need to identify those individuals who are extroverts and coach them appropriately so that the extroverts do not dominate the meeting discussion and sideline the potential contribution from the introverts for the successful outcome of the meeting.

A voice tallying system of the present invention would identify the silent participants in a meeting and would enable professional coaches to train those silent participants to participate actively in a discussion. Similarly in a corporate setting, where an employee is expected to actively contribute to the discussions within the project teams, such a system would be useful for the manager in providing appropriate feedback during the performance management. For example, in a corporate product development team meeting, contribution from the marketing team representative is critical to understand the market potential for the product under development. When the marketing team representative is sitting quiet during the entire period of the meeting, everyone would assume that the product being developed has a good market potential even though there are competing products already in the market or similar products are being developed by competitors in the market place. Similarly, in a highly-regulated industry, the representative from regulatory affairs department is expected to actively participate in a product development team meeting when there is a need for obtaining regulatory approval before the product launch. Definitely there is a need to develop a voice tallying system to identify those participants in a meeting who are silent for most of the duration of the meeting and timely bring them into ongoing active discussion.

### SUMMARY OF THE INVENTION

This present invention provides a voice tallying system and a method for conducting effective meetings. More specifically, the present invention provides a tool to address the problem in conducting an effective meeting where all the participants are not actively participating.

The present invention has certain technical features and advantages. For example, the invention associates audio signals from the participants in a meeting with identification information of the participants in that meeting. Once the identity of a particular participant is established, it is possible to continuously monitor the audio signal from that participant for the purpose of establishing a voice tally score for that participant with reference to the voice tally score for the rest of the participants in that meeting. With that voice tally score, the moderator of a meeting can identify those attendees in that meeting who are not actively participating in the ongoing discussion and prompt those silent participants to get involved in the ongoing discussion so that the objective of the meeting is achieved. Alternately, at the end of the meeting, the moderator can provide feedback to those attendees who did not actively participate in the meeting so that those silent attendees can proactively participate and contribute to the success of subsequent meetings.

Embodiments of the present invention include a method, an article, and a system for tallying the participation of each of the participants in a meeting. The system, the method and the article of the present invention help in identifying those participants who are not actively participating in a meeting. By means of using the method, the article and the system of the present invention, it is possible to monitor the audio signal from each of the participants in a meeting. With a voice tally for each of the participants in a meeting, it is possible to identify those who are keeping quiet during the meeting and make them actively participate in the ongoing discussion and contribute to the successful outcome of the meeting.

The method according to the present invention includes: pre-recording the voice profile of participants in a meeting; identifying the participants during the meeting by comparing the audio signals of that participant with the pre-recorded voice profile; tagging the participation of each participant using their audio signal in real time during the entire duration of the meeting; and generating a voice tally for each participants in the meeting contemporaneously. Unlike a speech recognition method, the present method involves only voice identification and therefore complex models requiring knowledge of languages are not required to practice the present invention.

The article according to the present invention comprises one or more computer-readable storage media containing instructions that when executed by a computer enables a method for tallying the audio signal from each of the participants in a meeting based on the audio input from the participants.

The system according to the present invention for generating voice tally for each of the participants in a meeting in real time during conference includes: one or more voice recording equipment connected by a communication network; wherein the communication network is connected to a voice analysis module; wherein a memory component within the voice analysis module generates and stores the voice profile for each of the participants; an analyzer unit within the voice analysis module identifies speakers during the meeting by matching their audio signals stored in the memory unit within the voice analysis module; and a processor unit within the voice analysis module generates a voice tally for each of the participants in the meeting based on the audio signal from them.

As a further example, according to the present invention, the voice profile information for the participants in a meeting is updated during their participation in the meeting and as a result the voice profile information for each of the participant is further improved and subsequent identification of that participant becomes error-proof in the future meetings.

In certain embodiments, a system for tallying audio signals from plurality of participants in a teleconference call is provided. The audio signal from each of the participants is captured using a single or plurality of microphones and transferred to a voice analysis module within a computing device through a communication path. Depending on the configuration of the teleconference, a public or private communication network is also involved in the transmission of the audio signal from each of the participants in the teleconference to the voice analysis module within the computing device. The voice analysis module within the computing device comprises a memory, an analyzer and a processor. The memory unit associated with voice analysis module within the computing device has voice sampler from each of the participants in the teleconference and the analyzer has the capacity to identify the voice signal from each of the participants by comparing the voice signal from the participants with voice sampler stored in the memory. Once the analyzer establishes the identity of a participant in a teleconference, the processor calculates the duration of the time each participant is participating in the teleconference based on the audio signal received from each of the participants during the teleconference and tally the duration of participation for each of the participants. The voice tally generated by the processor unit is displayed on a display device either at the end of teleconference or contemporaneously.

Using this method according to the present invention, it is possible to identify those participants who are poorly participating or not at all participating in the discussion during the teleconference. The identity of participants with the lowest score in the voice tally is provided to the moderator of the teleconference either at the end of the teleconference or even while the teleconference is still ongoing so that a moderator of the teleconference can prompt those silent participants with lowest score in the voice tally to participate in the ongoing discussion.

In yet another aspect, the present invention provides a processor-readable medium comprising processor-executable instructions configured for calculating the voice tally for each participant in a teleconference.

### BRIEF DESCRIPTION OF THE DRAWINGS

To provide a more complete understanding of the present invention, especially when considered in light of the following written description, and to further illuminate its technical features and advantages, reference is now made to the following drawings. The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1. A functional block diagram of a voice tallying method according to the present invention.

FIG. 2. A block diagram for physical configuration of a voice tallying system useful in conducting a teleconference in accordance with one embodiment of the present invention.

FIG. 3. A functional block diagram of a voice analysis module in accordance with one embodiment of the present invention.

FIG. 4. A functional block diagram of an initialization module located within a voice analysis module in accordance with one embodiment of the present invention.

FIG. 5. A flow diagram for initialization process by the initiation module within the voice analysis module in accordance with one embodiment of the present invention.

FIG. 6. A sample table prepared by initialization module within the voice analysis module in accordance with one embodiment of the present invention.

FIG. 7. Voice tally for ten different attendees in a teleconference. Four of the ten attendees (1, 5, 7, and 8) did not participate in the discussion and have voice tally of 0% as shown in Table 2.

FIG. 8. A flow chart illustrating a method for identifying a participant during a conference call in accordance with one embodiment of the present invention.

FIG. 9. A block diagram for physical configuration of a voice tallying system useful in conducting a meeting at a single location in accordance with one embodiment of the present invention.

FIG. 10. A block diagram for physical configuration of a voice tallying system useful in conducting a meeting at a single location in accordance with one embodiment of the present invention.

FIG. 11. A block diagram for physical configuration of a voice tallying system useful in conducting a meeting at a single location in accordance with one embodiment of the present invention. Access to the voice tally display is provided only to the moderator of the meeting.

FIG. 12. A block diagram for physical configuration of a voice tallying system useful in conducting a meeting at a single location in accordance with one embodiment of the present invention. Access to the voice tally display is provided to the moderator of the meeting as well as to all the attendees of the meeting.

### DETAILED DESCRIPTION OF THE PREFERRED EMBODIMENTS

Reference is made herein in detail to specific embodiments of the invention. Specific examples are illustrated with drawings. The subject matters of embodiments of the present invention are provided herein to satisfy the statutory requirement. However, the description provided herein is not meant to limit the scope of the present invention. Rather the claimed subject matter of the present invention may be embodied in several other ways within the scope of the present invention.

The present invention provides a system, an article and a method for conducting effective meetings. Embodiments of the invention provide a method, an article and system for determining relative participation of all the participants in a meeting and for identifying participants who are either participating very rarely or not at all in a meeting. The relative participation of each of the participants in a meeting is quantified on the basis of recording audio signals from the individual participants and displayed as a voice tally.

The term “meeting” as defined in the present invention refers to any situation where there is a discussion involving plurality of individuals. It is not necessary that all attendees participating in the discussion are participating in the discussion. In fact, the very purpose of the present invention is to identify those attendees in a discussion group who are either silent for the entire duration of the discussion or very rarely participate in the ongoing discussion even though they have a lot to contribute to the ongoing discussion and their contribution is very much needed for the successful outcome of the discussion. The term “meeting” as defined in the present invention includes the situation where all of the individuals selected for the discussion are present in a single location and there is a face-to-face interaction among the participants in the discussion group. This situation is referred as in-person meeting. Alternately, individuals selected for the discussion are located in multiple physical locations and the communication among the attendees is happening through a public or private communication network. This situation is referred as on-line meeting. The communication among the attendees in an on-line meeting can either be through an audio conference or a video conference and involves the steps of recording and analysis of audio signals from the attendees in one or more remote locations. As it is well known in the art, the video conference involves the exchange of both audio and video signals among the plurality of participants. However, the present invention is related only to the audio component of a video conference. In the present invention, the terms meeting, discussion, group discussion, brain storming, conference, teleconference, audio conference and videoconference are used interchangeably and all these terms have the same functional definition as provided in this paragraph. In short, all these terms refers to communication among plurality of individuals using audio signals.

The term “participant” as used in the present invention refers to any individual who has been invited or asked or required to attend a meeting irrespective of the fact whether that individual is actively participating in the meeting or not. The terms “attendee” and “participant” are used interchangeably and both these terms fit into the definition provided in the previous sentence. The term “voice tally” as used in the present invention refers to an end result of a calculation which provides a list of the attendees in a meeting and the duration during which each of the attendees participated in the meeting. As defined in this present invention the term “participation” in the context of voice tally refers to the duration during which the participant uttered something. In other words, the term “participation” means the duration during which the particular attendee was speaking and the rest of the attendees are in listening mode. The voice tally can be displayed in a variety of ways. For example it can be displayed as a table providing the percentage of times during which each of the attendee was speaking in the meeting. The display may be in the form of a pie chart. The term “voice tallying system” as used in the present invention refers to an assembly of a hardware and software components that makes it possible to calculate and display a voice tally for a particular meeting. The voice tally system may be a stand-alone device or can be integrated into a computing device such a desktop computer, lap top computer, mainframe computer, tablet computer or even a hand-held smart phone.

The term “teleconference” as used in the present invention includes teleconference involving only an audio function as well as teleconference involving both audio and video functions. The teleconference equipment/system suitable for the present invention may optionally include WebEx function where the participants will have online access to documents. The list of commercially available teleconference equipment/service suitable for the present invention include, among others, Cisco Collaboration Meeting Rooms (CMR) Cloud, Citrix mobile workspace apps and delivery infrastructure, analog conference phones deployed on the global public switched telephone network, VoIP Conference phone optimized to run on current and emerging IP network, Microsoft conference phones qualified for Skype for Business and Microsoft Lync deployments and USB Speakerphone with the capability for simple, versatile solutions for communications on the go, Revolabs Executive Elite™ Microphones from Polycom and any hand-held mobile smart phones.

Humans have inherent ability to distinguish between the speakers. During the last fifty years, systems have been developed to recognize human voice. Speaker recognition has emerged as an independent field of study touching upon computer sciences, electrical and electronic engineering and neuro sciences. Speaker recognition is now defined as the process of automatically recognizing who is speaking on the basis of individual information included in speech signal. Speaker recognition technology finds its application in voice dialing, banking over network, telephone shopping, data base access services, information and reservation services, voice mail, security control for confidential information and remote access to computer.

Speaker recognition includes two categories namely speaker verification and speaker identification. Technology has been developed to achieve speaker verification as well as speaker identification. The objective of the system designed for speaker verification is to confirm the identity of the speaker. In other words, the speaker identification system tries to make sure that the speaker is the person who we think he or she is. Speaker verification process accepts or rejects the identity claim of a speaker. In terms of actual functioning, the speaker verification system tries to see if the voice of the speaker matches with a pre-recorded voice profile for that particular person. Speaker verification is used as a biometric tool to identify and authenticate the telephone customers in the banking industry within a brief period of conversation. On the other hand, in terms of actual functioning, the system designed for speaker identification tries to match the voice profile of a speaker with a multitude of pre-recorded voice profiles and establish the identity of the speaker. It is well known in the field that the speaker identification technology may be used in criminal investigation. Speaker identification technology can also be used to rapidly match a voice sample with thousands, even millions of voice recordings and therefore be used to identify callers in enterprise contact center settings where security is a major concern. The present invention provides a yet another new application for the speaker identification technology. The voice tallying system of the present invention is based on speaker identification technology.

Both speaker identification and speaker verification technologies involve two phases namely enrollment phase and verification phase. In the enrollment phase, the voice of number of speakers are recorded and a number of features from each of the speaker's voice are extracted to create a voice profile (also generally referred as voice print, template or model) unique to individual speakers. In the verification phase, a speech sample or an utterance from a particular speaker is compared against voice profiles created at the enrollment phase. In the case of a speaker verification system, the utterance of a speaker is compared against the voice profile of the speaker recorded at the enrollment phase for the purpose of confirming that speaker is the same person he or she claims to be. In the case of speaker identification system, the utterance of a speaker is compared to multiples of voice profiles recorded at the enrollment phase in order to determine the best match for the purpose of establishing the identity of the speaker. The present invention is based on the technologies currently available for speaker identification.

Speaker recognition technology (including both speaker verification and speaker identification systems) is divided into two categories namely text-dependent and text-independent technologies. In the case of text-dependent speaker recognition technology, the same text is used both at the enrollment phase and verification phase. The text used in the text-dependent speaker recognition technology can be same for all the speakers or customized to individual speakers. In general, the text-dependent speaker recognition technology is always supplemented by additional authentication procedures such as password and PIN to establish speaker's identity. On the other hand, in the text-independent system, the texts used in the utterance at the enrollment phase and the verification phase need not be the same. The text-independent technologies do not compare what was said at enrollment and verification phases but focus on acoustics and speech analysis techniques either to establish verification or identification of the speaker. The present invention is based on the text-independent speaker identification technology.

Another important aspect of speech research that is highly relevant to the instant invention is speaker diarization. Speaker diarization is the process of automatically splitting the audio recording into speaker segments and determining which segments are uttered by the same speaker (the task of determining “who spoke when?”) in an audio or video recording that involves an unknown amount of speech and unknown number of speakers. Speaker diarization is a combination of speaker segmentation and speaker clustering. Speaker segmentation refers to a process for finding speaker change points in an audio stream and splitting an audio stream into acoustically homogenous segments. The purpose of speaker clustering is to group speech segments based on speaker voice characteristics in an unsupervised manner. During the process of speaker clustering all speech segments uttered by the same speaker are assigned a unique label. Two different types of clustering approaches namely deterministic and probabilistic ones are known in the art. The deterministic approaches cluster together similar audio segments with respect to a metric, whereas the probabilistic approaches use Gaussian mixture model and hidden Markov model. State of-the-art speaker segmentation and clustering algorithms are well known in the field of speech research and are effectively utilized in the applications based on speaker diarization. The list of applications for speaker diarization includes speech and speaker indexing, document content structuring, speaker recognition in the presence of multiple speakers and multiple microphones, movie analysis and rich transcription. Rich transcription adds several metadata in a spoken document, such as speaker identity, sentence boundaries, and annotations for disfluency. The present invention provides yet another novel application, namely voice tallying, for the use of speaker segmentation and clustering algorithms.

In its simplest embodiment, the system and the method in accordance with the present invention involve the use of voice tallying software for obtaining a voice tally for each of the attendees in a meeting. The term voice tallying software as defined in the present invention is a processor-readable medium comprising processor-executable instructions for (1) receiving and storing sample audio signals from each of the participants in a meeting before beginning of the meeting; (2) receiving and analyzing the audio signals from the plurality of participants during the meeting; and (3) preparing a voice tally for each of the participants in the meeting. Thus the voice tallying software has three functional components and each of these three functional components has ability to function independent of each other.

The audio signal from each of the participants recorded for the purpose of identifying the participant during the meeting is referred as voice profile of the participants. The voice profile of the participant may be recorded immediately before the beginning of the meeting when the participants introduce themselves. The participants in a meeting usually introduce themselves at the beginning of the meeting by stating their name, their affiliation and the title within the organization they work. Alternately for the purpose of more accurate voice recognition, the voice profile of the participants may be recorded by requesting the participants to utter one or more sentences solely for the purpose of recording their voice profiles. The voice profile recorded for one meeting can be stored in the system and used in the subsequent meetings.

The present invention may be implemented using generally available computer components and speech dependent voice recognition hardware and software modules. Voice recognition is a well-developed technology. Voice recognition technology is classified into two types namely, (1) speaker-independent voice recognition technology and (ii) speaker-dependent voice recognition technology.

As defined in the present invention, the speaker-independent voice recognition technology aims at deciphering what is said by the speaker while the speaker-dependent voice recognition technology aims at obtaining the identity of the speaker. The use of speaker-independent voice recognition technology is in the identification of the spoken words irrespective of the identity of the individual who uttered the said words while the use of the speaker-dependent voice recognition technology is in the identification of the speaker who uttered those words. Thus the speaker-independent voice recognition technology uses a dictionary containing reference pattern for each spoken word. On the other hand the speaker-dependent voice recognition technology is based on a dictionary containing specific voice patterns inherent to individual speakers. Thus the speaker-dependent voice-recognition technology uses a custom-made voice library.

The speaker-dependent voice recognition technology is suitable for the instant invention. Using currently available speaker-dependent voice recognition technology, it is possible to establish the identity of a speaker in a meeting by comparing the pattern of an input voice from the speaker with a stored reference patterns and calculating a degree of similarity there between. The voice analysis system used in the speaker-dependent voice recognition technology samples the electrical signal from microphone of the speaker and generate a single positive or negative value corresponding to the distance of the membrane within the speaker from its normal position. The voice analysis system may sample the electrical signal at a rate of 16 kHz (that is 16,000 times per second). The sound samples are collected into groups of 10 milliseconds long, referred as speech frames. The voice analysis system may perform frequency analysis of each speech frame using Fourier transforms, suitable algorithms or any other suitable frequency analysis techniques. After the completion of frequency analysis, the voice analysis system compares the features with a model speech frame in the voice sample stored in the custom-made voice library.

In applying the speaker-dependent voice recognition technology to the present invention, the following four different functional steps are followed: (1) enrollment, (2) feature extraction, (3) similarity measurement and utterance recognition and (4) voice tallying. During the enrollment stage a set of feature vectors for each participant in a meeting is created and stored in the dictionary. The term enrollment as used in this invention also includes the term roll-call. Roll-call is a process in which either the moderator of a meeting goes through the list of the attendees invited for the meeting to find who are all present in the meeting. Alternately, during the roll-call process at the beginning of the meeting, the attendees introduce themselves by means of stating their name and their credentials appropriate to the meeting. In the present invention, self-introduction by each of the attendees during the roll-call process is preferred. The objective of roll-call process wherein the attendees introduce themselves is to provide energy-based definition of start/stop time for an initial reference pattern for each speaker. During the meeting, the initial reference pattern for each speaker stored in the dictionary may be updated to improve the identification of the speaker as the meeting progresses.

Once the meeting starts, the incoming audio signals are continuously processed for extracting various time-normalized features which are useful in speaker-dependent voice recognition. A number of well-known signal processing approaches such as direct spectral measurement, mediated either by a bank of band pass filters or by a discrete Fourier transform, the cepstrum, and a set of suitable parameters of a linear predictive coding (LPC) are available for representing a speech signal in a temporal scale.

Once time-normalized parameters have been extracted from the incoming audio signals representing utterances of a speaker in a meeting, the next phase of computing similarity between the extracted features and stored reference is followed and a determination is made as to whether the similarity measure is sufficiently small to declare that the identity of the speaker is recognized. Several different major algorithms such as auto correlation, matched residual energy distance, computation, dynamic programming, time alignment, event detection and high level post processing are used to measure the similarity between the incoming voice signals and sample voices stored in the system according to the present invention. In one approach, the recognition is achieved by performing a frame-by-frame comparison of speech data using a normalized predictive residual (F. Itakura, “Minimum Predictive residual Principle Applied to Speech Recognition.” IEEE Trans Acoust. Speech Signal Processing, ASSP-23, 67-72, 1975). Once the identity of the speaker is established, the participation of that speaker in the meeting is tagged temporally and a voice tally is computed for that speaker in the meeting with reference to other speakers in the meeting. During the phase of voice tallying, a running sum of time dominated by each of the participant in the meeting is calculated and running sum is displayed as a percentage of the total duration of the conference.

In the representative embodiments of the present invention, the identity of a participant in a teleconference is determined by identification of the audio signal from that participant. The ability to associate identification information with the audio signal is particularly useful when a single microphone is used by multiple participants in a meeting. The voice identifying phase takes output parameters generated at the enrollment phase and compares it with voice sample stored in the custom-made voice library. Training will be initiated at the beginning of a given session. Each participant in a conference will be required to provide a voice sample during the enrollment phase so that a unique set of voice parameters is stored in the custom-made voice library for voice tallying in accordance with the present invention.

In one of the simplest embodiment of the method for obtaining voice tally according to the present invention there are three major phases and all these three phases are implemented in real-time using software designed to capture and analyze the audio signals from the participants in the meeting. The three major phases towards obtaining voice tally according to this particular embodiment are: (1) voice analysis, (2) voice identification and (3) voice tallying. All these three phases are implemented in real time and as a result by using the system and following the method in accordance with the present invention, it is possible to obtain the voice tally for the participants in a meeting in real time while the meeting is still ongoing.

In any speaker identification system, sampled speech data is provided as an input and an index of identified speakers is obtained as the output. Three important components of a speaker identification system are feature extraction component, the speaker voice profile and matching algorithm. Feature extraction component receives the audio signals from the speakers and generates speaker specific vectors from the incoming audio signals. Based on the speaker specific vectors generated by the feature extraction component, a voice profile is generated for each speaker. The matching algorithm performs analysis on the speaker voice profiles and yields an index of speaker identification. Feature extraction component is considered as the most important part of any speaker identification system. Those features of speech which are not susceptible to conscious control by the speaker or health conditions of the speaker and independent of speaking environment are suitable for the speaker recognition (identification) according to the present invention.

A number of speech feature extraction tools such as linear predictive coding, cepstrum analysis and a mean pitch estimation made using the harmonic product spectrum algorithm are well known in the art of speech recognition and all of those tools are useful in the practicing the instant invention related to voice tallying system. All these software for speech feature extraction may be created using Matlab.

Pitch is considered as a feature suitable for the present invention among other features of speech. Pitch originates in the vocal cord/folds and the frequency of the voice pitch is the frequency at which the vocal folds vibrate. When the air passing through the vocal folds vibrates at the frequency of pitch, harmonics are also created. The harmonics occur at integer multiples of the pitch and decrease in amplitude at a rate of 12 dB per octave—the measure between each harmonic.

The sound from human mouth passes through laryngeal tract and supralaryngeal/vocal tract consisting of oral cavity, nasal cavity, velum, epiglottis and tongue. When the air flows through the laryngeal tract, the air vibrates at the pitch frequency. When the air flows through the supralaryngeal tract, it begins to reverberate at particular frequencies determined by the diameter and length of the cavities in the supralaryngeal tract. These reverberations are called “resonances” or “formant frequencies”. In speech, resonances are called formants. Taken together the pitch and formant can be useful to characterize an individual speech.

In the first step of feature extraction, the non-speech information and the noise in the audio signal is removed. After removing the non-speech component, the voice recording is analyzed in 20 ms frames and those frames with energy less than the noise floor are removed. The most commonly used features in speaker recognition systems are the features derived from the cepstrum. The fundamental idea of cepstrum computation in speaker recognition is to discard the source characteristics because they contain much less information about the speaker identity than the vocal tract characteristics. Mel Frequency Cepstral Coefficients (MFCC) are well known features used to describe speech signal. They are based on the known variations of the human ear's critical bandwidths with frequency. MFCC introduced in 1980s by David and Mermelstein are considered as the best parametric representation of the acoustic signals useful in the recognition of the speakers.

Speech data is subjected to pre-processing to improve the results. Feature extraction is a process step where computational characteristics of the speech signal are mined for later investigation. Time domain signal features are extracted by employing Fast Fourier Transfer in Mat lab. The features that are desirable are physical features and include Mel-frequency cepstral coefficients, spectral roll-off, spectral flux, spectral centroid, zero-cross rate, short-term energy, energy entropy and fundamental frequency.

The phase of voice analysis involves the extraction of the speech quality parameters via microphone in front of the speaker. Possible speech quality parameters useful in the voice analysis include but not limited to: (a) F₀: Fundamental frequency; (b) F₁-F₄: first to fourth formants; (c) H₁-H₄: first to fourth harmonics; (d) A₁-A₄: amplitude correction factors corresponding to respective harmonics; (e) Time-windowed root mean squared (RMS) energy; (f) CPP: Cepstral peak prominence; and (g) HNR: Harmonic-to-noise ratio (See J. Hillenbrand and R. A. Houde, “Acoustic Correlates of Breathy Vocal Quality: Dysphonic Voices and Continuous Speech”, Journal of Speech and Hearing Research, 39: 311-321(1996); M. Iseli, Y-L. Shue and A Alwan, “Age, Sex and Vowel Dependencies of Acoustic Measures Related to the Voice Source”, Journal of Acoustic Society of America, 121, 2283-2295 (2007); J. Hillenbrand, R. A. Cleveland, and R. L. Erickson, “Acoustic Correlates of Breathy Vocal Quality”, Journal of Speech and Hearing Research, 37: 769-778 (1994); H. Kaot, and H. Kawahara, “An Application of the Bayesian Time Series Model and Statistical System Analysis For F0 Control”, Speech Communication, 24: 325-339 (1998); G. deKrom, “A Cepstrum-Based Techniques for Determining a Harmonics-to-Noise Ratio in Speech Signals”, Journal of Speech and Hearing Research, 36: 254-266 (1993)). The speech quality parameters useful in the voice analysis according to the present invention are well known to a person skilled in the art of voice recognition. In addition, the following United States Patent documents provide a detailed account of various speech quality parameters followed in the present invention. All of these U.S. Patent documents are incorporated herein by reference.

U.S. Pat. Nos. 3,496,465 and 3,535,454 provide fundamental frequency detector useful for obtaining the fundamental frequency of a complex periodic audio signal. U.S. Pat. No. 3,832,493 provides a digital speech detector. U.S. Pat. No. 4,441,202 provides a speech processor. U.S. Pat. No. 4,809,332 provides a speech processing apparatus and methods for processing burst-friction sounds. U.S. Pat. No. 4,833,714 provides a speech recognition apparatus. U.S. Pat. No. 4,941,178 provides a speech recognition using pre-classification and spectral normalization. U.S. Pat. No. 5,214,708 provides a speech information detector. U.S. Pat. No. 7,139,705 provides a method for determining the time relation between speech signals affected by warping. U.S. Pat. Nos. 7,340,397 and 7,490,038 provide a speech recognition optimization tool. U.S. Pat. No. 7,979,270 provides a speech recognition apparatus and method. U.S. Patent Application Publication No. 2012/0089396 provides an apparatus and method for speech analysis. U.S. Pat. No. 9,076,444 provides a method and apparatus for sinusoidal audio coding and method and apparatus for sinusoidal audio decoding. U.S. Pat. No. 9,076,448 provides a distributed real time speech recognition system.

U.S. Pat. No. 4,081,605 provides a speech signal fundamental period extractor. U.S. Pat. No. 4,377,961 provided a fundamental frequency extracting system. U.S. Pat. No. 5,321,350 provides a fundamental frequency and period detector. U.S. Pat. No. 6,424,937 provides a fundamental frequency pattern generator, method and program. U.S. Pat. No. 8,065,140 provides a method and system for determining predominant fundamental frequency. U.S. Pat. No. 8,554,546 provides an apparatus and method for calculating a fundamental frequency change.

U.S. Pat. No. 4,424,415 provides a formant tracker for receiving an analog speech signal and generating indicia representative of the formant. U.S. Pat. No. 4,882,758 provides a method for extracting formant frequencies. U.S. Pat. No. 4,914,702 provides a formant pattern matching vocoder. U.S. Pat. No. 5,146,539 provides a method for utilizing formant frequencies in speech recognition. U.S. Pat. No. 5,463,716 provides a method for formant extraction on the basis of LPC information developed for individual partial bandwidths. U.S. Pat. No. 5,577,160 provides a speech analysis apparatus for extracting glottal source parameters and formant parameters. U.S. Pat. No. 6,206,357 provides a method for first formant location determination and removal from speech correlation information for pitch detection. U.S. Pat. No. 6,505,152 provides a method and apparatus for using formant models in speech systems. U.S. Pat. No. 6,898,568 provides a speaker verification utilizing compressed audio formants. U.S. Pat. No. 7,424,423 provides a method and apparatus for formant tracking using a residual model. U.S. Pat. No. 7,756,703 provides a formant tracking apparatus and formant tracking method. U.S. Pat. No. 7,818,169 provides a formant frequency estimation method, apparatus, and medium in speech recognition.

U.S. Pat. No. 5,574,823 provides frequency selective harmonic coding. U.S. Pat. No. 5,787,387 provides a harmonic adaptive speech coding method and system. U.S. Pat. No. 6,078,879 provides a transmitter with an improved harmonic speech coder. U.S. Pat. No. 6,067,511 provides LPC speech synthesis using harmonic excitation generator with phase modulator for voiced speech. U.S. Pat. No. 6,324,505 provides an amplitude quantization scheme for low-bit-rate speech coders. U.S. Pat. No. 6,738,739 provides a voiced speech preprocessing employing waveform interpolation or a harmonic model. U.S. Pat. No. 6,741,960 provides a harmonic-noise speech coding algorithm and coder using cepstrum analysis method. U.S. Pat. No. 6,983,241 provides a method and apparatus for performing harmonic noise weighting in digital speech coders. U.S. Pat. No. 7,027,980 provides a method for modeling speech harmonic magnitudes. U.S. Pat. No. 7,076,073 provides a digital quasi-RMS detector. U.S. Pat. No. 7,337,107 provides a perceptual harmonic cepstral coefficient as the front-end for speech recognition. U.S. Pat. No. 7,516,067 provides a method and apparatus using harmonic-model-based front end for robust speech recognition. U.S. Pat. No. 7,521,622 provides a noise-resistant detection of harmonic segments of audio signals. U.S. Pat. No. 7,567,900 provides a harmonic structure based acoustic speech interval detection method and device. U.S. Pat. No. 7,756,700 provides a perpetual harmonic cepstral coefficient as the front-end for speech recognition. U.S. Pat. No. 7,778,825 provides a method and apparatus for extracting voiced/unvoiced classification information using harmonic component of voice signal. U.S. Pat. No. 8,515,747 provides a method for spectrum harmonic/noise sharpness control.

Multiple speech quality parameters can be extracted from audio recording of the speech using VoiceSauce, a software program developed at the Department of electrical Engineering, University of California, and Los Angeles, Calif., USA. VoiceSauce provides automated measurements for the following speech parameters: F0 and harmonic spectra magnitude, formants and corrections, Subharmonic-to-Harmonic Ratio (SHR), Root Mean Square (RMS) energy and Cepstral measures such as Cepstral Peak Prominence (CPP) and Harmonic-to-Noise Ratio (HNR). In computing these various speech parameters VoiceSauce uses a number of algorithms known in the field of speech research. Fundamental frequency F0 is one of the critical measurements made by VoiceSauce. VoiceSauce uses three different algorithms to find F0 at 1 ms intervals. and based on this calculations estimates the location of harmonics. VoiceSauce is implemented in Matlab and is useful in extracting the speech quality parameters listed above in this paragraph.

In practicing the instant invention, one could use the VoiceSauce program in the following manner. Each participant in a conference will be required to provide a voice sample at the beginning of the conference to be analyzed by the VoiceSauce program. Pre-trained values for speech parameters for N-number of participants are obtained using the VoiceSauce program at the beginning of the conference and stored in the memory unit. At the end of the conference the output voice parameters from the VoiceSauce program is compared with pre-trained values for N-number of participants' voice parameters stored in the memory unit and the conference attendees who participated in the discussion during the conference are identified. Based on this analysis, duration of the participation for each of the participant in the conference is also calculated. The data resulting from the analysis of temporal participation of various participants is used to create a voice tally table for the conference. Such a voice valley table besides identifying the attendees who never participated or very minimally participated in the discussion would also identify the attendees who dominated the conference. Alternatively, the system can be configured with appropriate algorithm so that the voice tally table for the conference can be created instantaneously while the conference is still in progress.

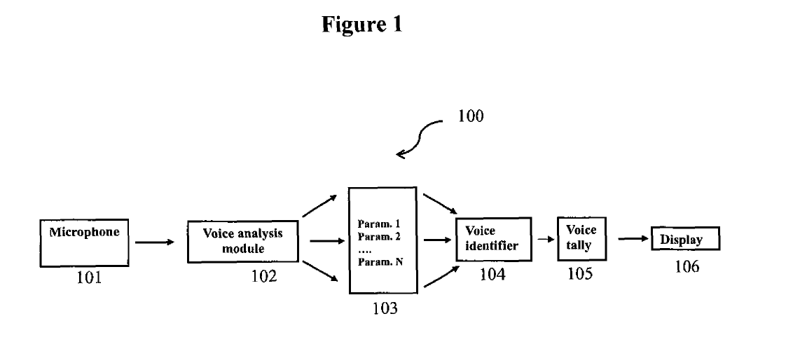

FIG. 1 illustrates the functional configuration of various phases in the voice tallying method 100 according to the present invention. The microphone 101 picks up the audio signal from a speaker in a meeting and sends that audio signal to a voice analysis module 102. Within the voice analysis module 102, the audio signal is analyzed using one or other speech parameters selected from a group consisting of 103₁ to 103_{N} and stores unique voice profile for each of the participants in the meeting. When the voice identifier 104 receives an audio signal from a participant speaking in the meeting, the current speaker's identity is established by comparing the voice profile of the current speaker with those profiles stored in the voice analysis module 102. Once the identity of a speaker in a meeting is established, the voice tally unit 105 calculates running sum of time dominated by that particular speaker and the voice tally is provided on a display 106.

In one embodiment of the voice tallying system according to the present invention, the audio signals from each of the participants are transferred to a voice analysis module through a communication path. The voice analysis module 102 is an integral part of a computing device. At the voice analysis module 102, the audio signals from each of the participants is identified, processed and displayed as a voice tally and thereby facilitating the identification of individuals who are rarely participating or not at all participating in the discussions during the meeting

During a teleconference, communication among plurality of people is established through a public or a private communication network. The term teleconference is synonymous to the term conference call and therefore these two terms are used interchangeably in the present invention.

For successful teleconference, it is necessary that at any one time during a teleconference only one participant among the plurality of the participants in the teleconference is allowed to speak and the rest of the participants are in a listening mode. Only when the said speaking participant finishes talking, any other participant among the plurality of the participants is allowed to talk. Thus at any time during the teleconference, there is only one speaking participant and the rest of the participants are in a listening mode. This is the norm in conducting a teleconference and it is also a highly favored way of conducting a teleconference. This practice of allowing only one participant to speak at a time during a teleconference conference is not only necessary for improving the efficiency of communication among the plurality of participants in a teleconference but is also essential for achieving the objective of the present invention.

In one embodiment of the present invention, all of the participants in a teleconference are at a single physical location. In another embodiment of the present invention, some of the participants in a teleconference are present at one primary physical location and the rest of the participants are physically located at one or more remote locations. The term “primary location” refers to the location where majority of the participants in a teleconference are physically located or where the system responsible for accomplishing the objective of the present invention is physically present. It is also possible that the system responsible for accomplishing the objective of the present invention can also be located any location other than “primary location”. The term “remote location” as defined in the present invention is a relative term. The participants at a remote location may be situated in a location next door or next floor to the primary location in the same building or may be in a different building adjacent to primary location, or in a different location in the same town or in a different town, in a different state, in a different country or even in a different continent with reference to the primary location.

As defined in the present invention, the term “communication” refers to audible exchange of information among plurality of people. The communication among the plurality of people may be either audio communication or audiovisual communication. The audio communication and audiovisual communication may be accompanied by data sharing. However, the key component in the communication among plurality of the people that is useful in the method, the article and the system according to the present invention is the audio component of the communication based on the voice of the plurality of the participants in a meeting.

According to the present invention, there is an audio equipment in front of each of the plurality of participants. Audio equipment suitable for the present invention includes one or more microphones, speakers, and the like. The microphone component of the audio equipment picks up the voice of the participant in front of the audio equipment and generates an electrical or digital signal that is transmitted to the audio equipment in front of the other participants in a meeting and to the voice analysis module through a communication network. The speakers within the audio equipment in front of participants in a listening mode in a teleconference reproduce and amplify the audio signal from the electrical or digital signal received from the communication network. Thus the basic requirement for the audio equipment suitable for the method according to the present invention are capabilities for (1) capturing the audio signals from a speaking participant in a teleconference; (2) converting the audio signal into an electrical or digital form suitable for transmission across the communication network; (3) transmitting the electrical or digital signal into communication network; (4) receiving the electrical or digital form of audio signals across from the communication network; and (5) converting the electrical or digital signals back into audio signal in the audio equipment in front of the participant in a listening mode. Thus when a participant speaks in a teleconference, instantaneously the audio equipment situated in front of the participants in a listening mode receives the electrical or digital signal from the communication network and convert the said electrical or digital signal back into audio signal so that the participants in the listening mode in a teleconference are able to listen what is being said by the participant speaking in the teleconference. Thus each audio equipment in front of each participant has a dual function and acts both as a microphone and as a speaker. The list of the audio equipment useful for the present invention includes landline telephones connected through public switched telephone network, personal computers, personal digital assistants, cell phones, smart phones, desk-mounted microphone/speaker or any other type of device that can receive data representing audible sounds and identification information. The microphone component of the audio equipment useful for the present invention is also referred as the voice recording devices as it captures the audio signals from the speaker in front of it and transmits it to the voice analysis module and to other participants in a meeting through a communication network.

In the system and method according to the present invention, the audio equipment used by the participants are connected to a voice analysis module through a communication network.

The audio equipment suitable for the present invention can be in different shapes, forms and functional capabilities. It may be a stand-alone equipment or may be a part of another equipment such as a video camera or land-line telephone, a mobile telephone or a phone operated using voice operated internet protocol. Any audio equipment that could instantaneously transmit the audio signal to the communication network is suitable for use in the system, the article and the method according to the present invention. When a meeting involves participants who are all located in a single location, the audio equipment may be represented by stand-alone microphone/speaker devices and the voice analysis module may be located in the same location and the connection between the stand-alone microphone/speaker devices and the voice analysis module is established without involving any communication network. When a teleconference involves participants using stand-alone microphone/speaker and remote participants joining the teleconference using land-line telephones, mobile phones, and internet phones operated using voice-operated internet protocol, the connection to the voice analysis module and the audio equipment may be established in several different ways. In one embodiment, where the voice analysis module is situated in the same location where participants using the stand-alone microphone/speaker are located, the stand-alone microphone/speakers are connected directly to the voice analysis module and the audio equipment used by the remote participants are connected to the voice analysis module through a communication network. In another embodiment, where the voice analysis module and the stand-alone microphone/speakers are located in different locations, the connection between the voice analysis module and the stand-alone microphone/speakers is established through a communication network as is the case with the connection between the remote participants using one or other audio equipment and the voice analysis module.

As defined in the present invention, the term “communication path” refers to the connection between the audio equipment and the voice analysis module. The communication path between the audio equipment and the voice analysis module may involve a communication network depending on the embodiments of the present invention. In some embodiments, where the communication device is represented by stand-alone microphones/speakers and the voice analysis module is located in the same location as the stand-alone speakers/microphones and there is no other remote participants using any other audio equipment, the communication path is represented by simple wiring between the stand-alone microphones/speakers and the voice analysis module and there is no involvement of any communication network. Under certain circumstances the communication can be established through wireless means.

As defined in the present invention, the term “communication network” refers to an infrastructure that facilitates the communication among plurality of people participating in a conference call. The communication network may be public or private. Also used in this specification is the term “communication path”. The term “communication path” refers to all the connection among the audio equipment used for voice recordings, computing device comprising voice analysis module, memory and processor and voice tally display unit. Thus the term communication path will also include the communication network. The terms communication path and communication network are used interchangeably in this specification. In a conference call, the audible signal coming from the audio equipment in front of the speaker is distributed to audio equipment in front of all other participants participating in the conference call. Thus each participant in a conference call may communicate with all of the other participants in the conference call. When the plurality of participants are present in a single location or in multiple locations with close proximity to each other, such as different rooms in a single building, the communication network involves simple wiring among the audio equipment in front of the plurality of the participants. It is also possible to use a wireless means as a communication path. When plurality of participants are at remote locations, communication network may involve Public Switched Telephone Network (PSTN), for transporting electrical representation of audio sounds from one location to another location and ultimately to the voice analysis module to calculate and display voice tally. The communication network according to the present invention may also involve the use of the packet switched networks such as the Internet when all of the participants or some of the participants among the plurality of the participants in a teleconference communicate through Voice Operated Internet Protocol (VOIP). Internet is capable of performing the basic functions required for accomplishing the objective of the present invention as effectively as the PSTN. In the internet protocol, the audio equipment when it is acting as a microphone encodes the audio signals received from the participant in the teleconference into digital data packets and transmits the packets into the packet switched communication network such as the Internet. At the same time, the audio equipment in front of the participant in the listening mode functioning as a speaker receives the digital packet that contain audio signals from the participant at the other end and decodes the digital signal back into audio signal so that the participant in the listening mode is able to hear what the speaker at the other end in a teleconference is saying.

Communication networks such as Public Switched Network and the packet switched networks besides establishing the connection among the plurality of audio equipment used by the plurality of participants in the teleconference also connect the plurality of the audio equipment to the voice analysis module when the participants are located at multiple remote locations.

In another embodiment of the present invention, the communication path among the audio equipment and the communication path between the audio equipment and the voice analysis module may be partly wireless and partly wired. For example, when a participant joins a teleconference using a mobile phone, the communication path from mobile phone to the mobile phone tower is wireless and the communication path from the mobile phone tower to the voice analysis module may be through a public switched telephone network or through a packet switched network depending upon the configuration of the communication network. Similarly, the communication among the plurality of the audio equipment in a teleconference may involve partly wireless and partly wired communication network. The wireless communication among the plurality of audio equipment used in a teleconference as well as the communication between the audio equipment and the voice analysis module is established though peripheral devices which are well known in the art of wireless communication.

Communication networks useful in the present invention are able to allow multiple people to participate in a conference call. The conference call can either be solely an audio call involving only the transfer of the audio signals from one audio equipment through the communication path to the other audio equipment and the voice analysis module. Alternately, the conference call may be a video call involving the transfer of both the audio and video signals from the speaker to the plurality of participants and to the voice analysis module through the communication path. Irrespective of the fact whether only an audio signal or a combination of an audio and a video signal is transmitted through the communication network during a conference call, only the audio signal is made use of in the system and the method in accordance with the present invention.

The audio equipment and or the stand-alone microphones/speakers, the communication network and the voice analysis module together provide a method and a system that use voice processing to identify a speaker during a meeting. Once the identity of the speaker is established, the method and the system according to the present invention determine the duration during which each of the participants in the meeting is speaking and provide a voice tally for each of the participants in the meeting.

The voice analysis module is an integral part of the method and the system according to the present invention and comprises a memory unit, an analyzer unit and a processor unit.

The functional role of the memory unit within the voice analysis module is to store the identity of the participants in a meeting. The identity of the participant can be established from the physical location of the participant. But such an approach for identifying the participant is error-prone as the participants may change their physical location during the meeting. The memory unit of the present invention overcomes such a limitation by means of using voice record of the participants in a meeting to identify a speaker at any time during the meeting. The memory unit has a stored voice record for plurality of participants in a meeting. The memory unit stores a database containing voice profile and identification information for the participants in a meeting. The voice record stored in the memory unit of the voice analysis module is created in advance either before the initiation of the meeting or at the beginning of the meeting when the participants are introducing themselves during the roll call phase of the meeting. As a further example, the voice profile information of a participant in the meeting may be updated during the meeting. As a result, with the progress of the meeting or in the future meetings, the voice profile information for that particular speaker will be more accurate. The voice record for a participant obtained for a meeting is stored in the memory and is used to identify the participant in the subsequent meetings at the same location or at some other location when it is possible to transmit the stored voice data from the original voice analysis module to another voice analysis module used in the subsequent meeting at a different location.

The analyzer unit is located within the voice analysis module. The analyzer unit is coupled to the memory unit and is operable to detect the reception of the audio signal and to determine whether the audible sounds represented by electrical or digital signal are associated with the voice profile information of one of the participants and generate a message including identification information associated with the identified voice profile information if the incoming voice profile corresponds to a voice profile already recorded and stored in the memory unit of the voice analysis module. The speaker recognition can be done in several different ways and the commonly used method is based on the hidden Markov models with Gaussian mixtures (HMM-GM). It is also possible to use artificial neural network, k-NN classifier and Support Vector Networks (SVM) classifier in speaker recognition. Artificial neural networks are computational models inspired by animal central nervous system and are capable of machine learning and pattern recognition. k-NN classifier is a non-parametric method for classification and regression. SVM classifiers are supported learning models with associated learning algorithms that analyze data and recognize patterns used for classification and regression analysis.

The information related to the identity of the speaker in a meeting obtained by the memory unit is subsequently used by the processor unit in achieving a voice tally for a particular participant in the meeting. Some embodiments of the present invention also include provisions for providing identification information of the speaker to the other participants in the meeting contemporaneously. The identification information of the speaker to the other participants in the meeting may include detailed information of the speaker such as the name, title, years of experience in the organization, expertise and hierarchy in the organization. The voice profile information of a participant in the meeting may be updated during the meeting and as a result the voice profile information for that participant will become more accurate as the meeting progresses.

The processor unit is coupled to the memory unit and the analyzer unit within the voice analysis module. The processor unit is operable to detect the reception of the audio signal from individual participants in a meeting. Once the analyzer establishes identity of participants in a meeting, the processor starts tagging the participation of each participant in a meeting and prepares a voice tally for each of the participants in a meeting based on the level of their participation in the meeting. The level of participation of a participant in a meeting is measured in terms of the duration of the audio signals received from that participant during the course of the meeting. The voice tally for each of the participants is displayed either as a bar graph, a pie chart or a table providing the percentage of total time used by the particular participant in the meeting.

The access to the voice tally display is provided either only to the moderator of the meeting or to all the participants in a meeting as required by the objective of the meeting. The voice tally can be displayed either at the end of the meeting or periodically during the meeting or contemporaneously all through the meeting.

The voice analysis comprising the memory unit, the analyzer unit and the processor unit along with the voice tally display is also referred as a “computing device”. The computer device comprising the voice analysis module and the voice tally display can be manufactured as a stand-alone, dedicated unit or alternately can be incorporated into routinely used commercial computers such as desktop computer, laptop computer, mainframe computer and tablet computer. It is also possible to incorporate the computing device (comprising voice analysis module and voice tally display) according to the present invention into a hand-held mobile smart phone as a result the mobile phone will have the voice analysis capacity and the ability to display the voice tally table.

In one embodiment of the present invention, the voice tally display generated by the processor unit for a particular meeting is used to give a feedback to the participants in that meeting about their participation in that particular meeting and the opportunities to improve their participation in the subsequent meetings. Such a feedback on the performance of the individual participant in the meeting is useful especially when the participant receiving the feedback is an introvert. In yet another embodiment, the present invention allow the moderator to prompt a particular participant to speak up when the contribution from that participant is valuable but that particular participant is maintaining silent. The voice tally data can also be used in the performance review of employees in an organization where the meetings are an integral part of the job responsibility and the equal participation of all the participants in the regularly scheduled meetings is very much desired for the overall success of the organization.

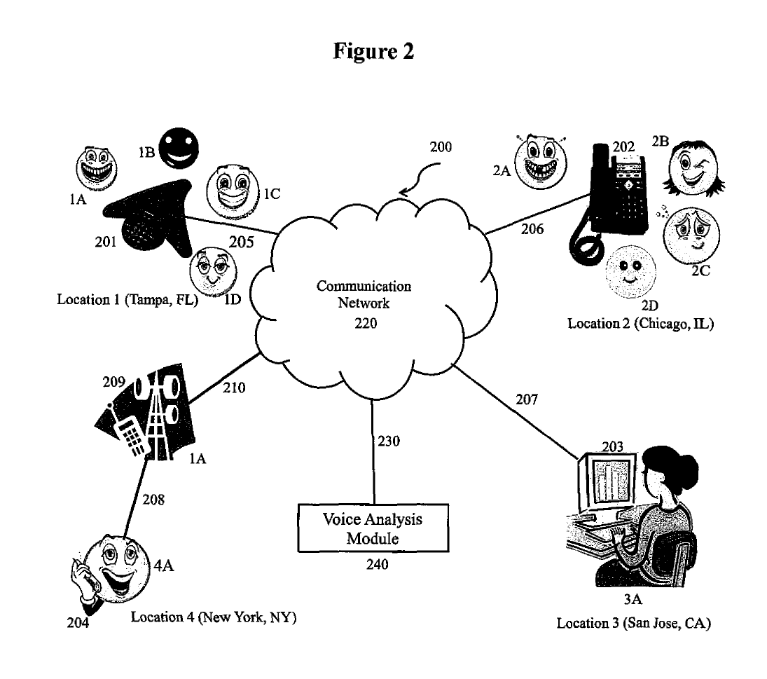

FIG. 2 is a block flow diagram for one of the embodiments of the present invention including teleconference system 200. Referring to FIG. 2, the system includes a plurality of locations (Locations 1, 2, 3 and 4). Each location is geographically separated from other locations. For example, Location 1 is in Tampa, Fla.; Location 2 is in Chicago, Ill.; Location 3 is in San Jose, Calif.; and Location 4 is in New York, N.Y. A person of reasonable skill in the art should recognize that any number of locations comes within the scope of the instant invention. One or more teleconference participants are associated with each location. Various locations might use variety of audio equipment such as landline phones, personal computers and mobile phones. For example, in FIG. 2, at Location 1, a landline telephone 201 is operated in a speaker mode and four participants 1A, 1B, 1C and 1D are participating in the teleconference. At Location 2 a PolyCom telephone 202 is used and the participants 2A, 2B, 2C and 2D are joining the teleconference. The connection between the audio equipment 201 and 202 to the communication network 220 is through a public switched telephone network 205 and 206 respectively. At Location 3, the participant 3A is using a personal computer 203 as an audio equipment to join the teleconference. The connection between the personal computer 203 at Location 3 and the communication network 220 is established through a packet switched network 207. There is a single participant 4A at Location 4 and he is joining the teleconference using a mobile phone 204. The mobile phone 204 is connected to a nearby mobile phone tower 209 through wireless means 208 and the connection 210 between the mobile phone tower 209 and the communication network 220 is established using either a public switched telephone network or packet switched network.

The communication network 220 might be an analog network or a digital network or combination of an analog and a digital network. The communication network 220 is connected to a voice analysis module 240 through a communication path 230. The voice analysis module might be located in one of the locations such as Location 1, Location 2 or Location 3 or it might be located in a totally different physical location. A person of reasonable skill in the art should recognize that it is within the reach of current technological advancements to accommodate the entire voice analysis module 240 within a hand-held mobile phone. Thus depending on the location of the voice analysis module 240, the connection between the voice analysis module 240 and communication network 220 might be through a wire link 230 or through a wireless route. In one aspect of this embodiment, the attendee at the Location 3 or Location 4 will have access to the voice tally table generated by the voice analysis module 240. The voice analysis table generated at either of these two locations (Location 3 and Location 4) can be stored at a desirable computer server and retrieved for a later use. It is also possible for the attendee at the Location 3 or the attendee at Location 4 to have access to the voice tally table instantaneously so that either one of these two attendees can act as the moderator and prompt the silent attendee to speak up in the teleconference.

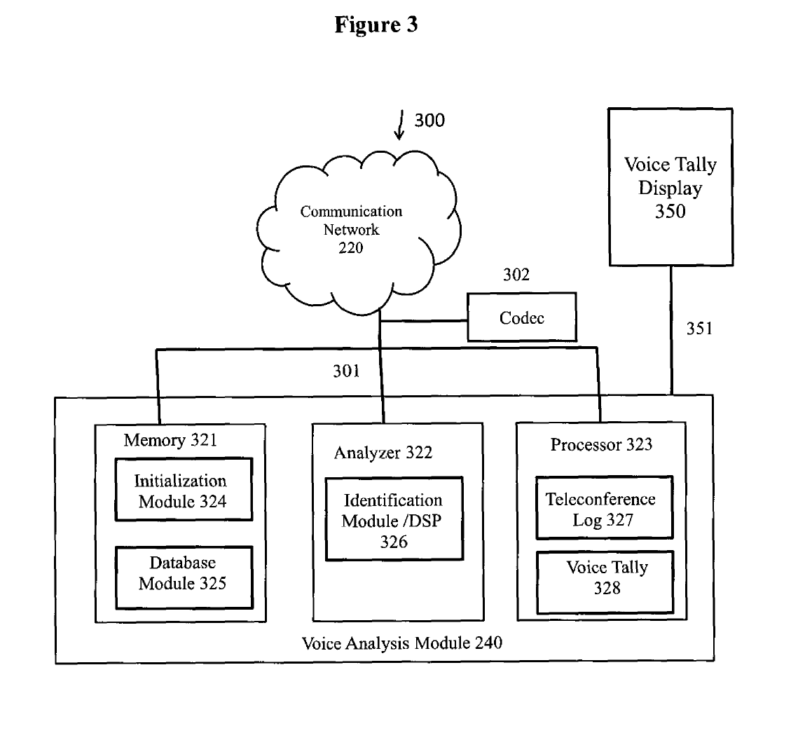

FIG. 3 shows a detailed functional organization of a voice tally system 300. As shown in FIG. 3, voice analysis module 240 comprises three different functional components namely memory unit 321, analyzer unit 322 and processor unit 323. A voice tally display 350 is connected to voice analysis module 240 through a connection 351. The voice tally display suitable for the present invention can be a computer monitor or any other liquid crystal display. In certain aspects of the invention, it is possible to entirely integrate the voice analysis module 240 within the voice tally display 350. Each functional unit within the voice analysis module 240 has been depicted as a separate physical entity in FIG. 3. These functional distinction and physical separation between the three units within the voice analysis module in FIG. 3 have been used only for the illustration purpose. A person of reasonable skill in the art should recognize the components within the voice analysis module can be combined and reconfigured in several different ways to increase the functional efficiency of the voice analysis module as well as to lower the cost of manufacturing of the voice analysis module. For example, all three components namely memory unit 321, analyzer unit 322 and processor unit 323 can be combined together as a single hardware unit. Alternately, the analyzer unit 322 and processor unit 323 can be combined together to create a single hardware unit with functional capabilities of both analyzer unit 322 and processor unit 323.

As shown in FIG. 3, audio signal from Communication Network 220 is conveyed independently to memory unit 321, analyzer unit 322 and processor unit 323 through communication path 301. The Codec 302 associated with the communication path is a device or computer program capable of encoding or decoding a digital data. Codec 302 converts analog signal from the desk set to digital format and converts digital signal from digital signal processor to analog format. Memory 321 unit perform the function of collecting the voice record for each of the participants in a meeting using a software program built within the initialization module 324 located within the memory unit 321. The software program within the initialization module 324 contains a set of logic for the operation of the initialization module 324.

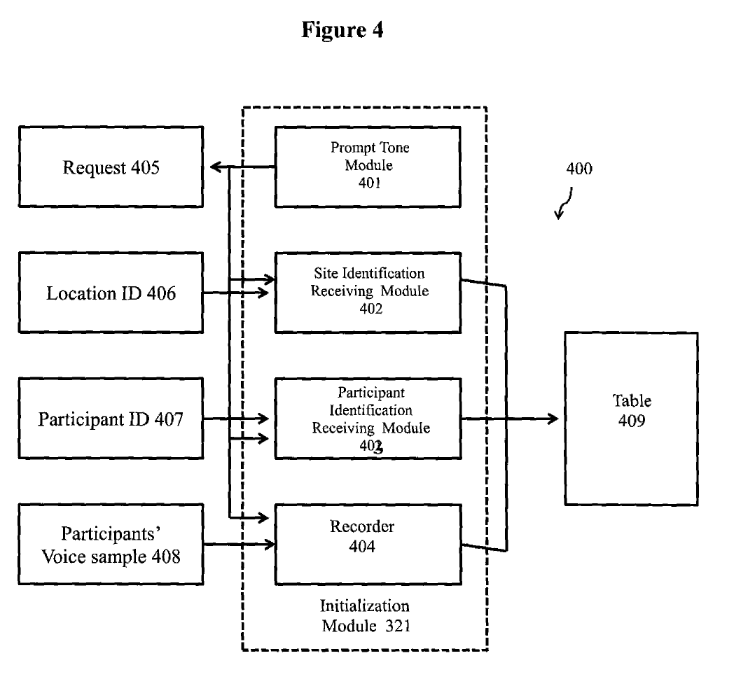

FIG. 4 provides a block diagram for the functional organization of the initialization module 324 within the voice analysis module 321. To begin with, the prompt tone module 401 within the initialization module 324 sends out a request 405 to one particular location among plurality of locations participating in the teleconference. In response to the request 405 from prompt tone module 401, each location in the teleconference sends out location ID 406, participant ID 407 for each of the participants at that location, and voice sample 408 for each of the participants at that location. Location ID is received and stored in the location ID receiving module 402 within the initialization module 324. Participant ID 407 is received and stored in the participant ID receiving module 403 within the initiation module 324. Voice sample 408 from each of the participant in a particular location is recorded at the recorder 404 within the initialization module 324. The data from these three components within the initialization module 324 namely, location ID reviving module 402, partisan ID receiving module 403 and recorder 404, are used to create a table 409.

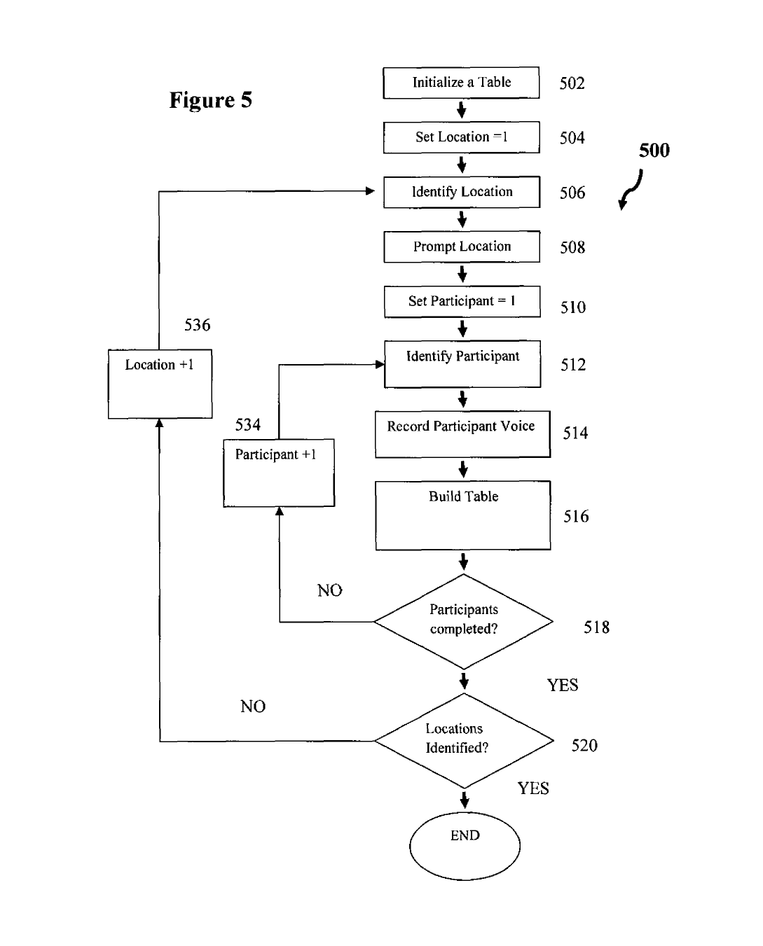

FIG. 5 is a flow chart 500 for the initialization process during the roll call. Initialization module 324 within memory unit 321 initializes a template table at the functional block 502 and at the functional block 504 sets up the Location 1 for building the table. At the functional block 506, the initialization module 324 identifies the location 1 and prompts the location 1 at the functional block 508 for the identification. Once Location 1 identifies itself, the initialization module 324 sets up the first participant at the location 1 in the functional block 510. The location identifies the participant 1 at that location in the functional block 512. At the functional block 514, the voice of the participant 1 at location 1 is recorded. Using the information gathered at the functional blocks, 508, 512 and 514, a table is built by the initialization module 324 at the functional block 516. This process is repeated until all the participants in location 1 are identified and their voices are recorded. Once identification information about all the participants and their voice samples are collected and incorporated into the table being built at the functional block 516, the initialization module 324 set up the next location (location 2) and the whole process is repeated until all the participants in the second location are identified and their sample voice recorded in the table being built at the functional block 516. This process is repeated with the next location in the conference call and comes to an end at the functional block 520 when all the participants in all the locations participating in the conference call are identified and their voice samples recorded in the table being created at the functional block 516.

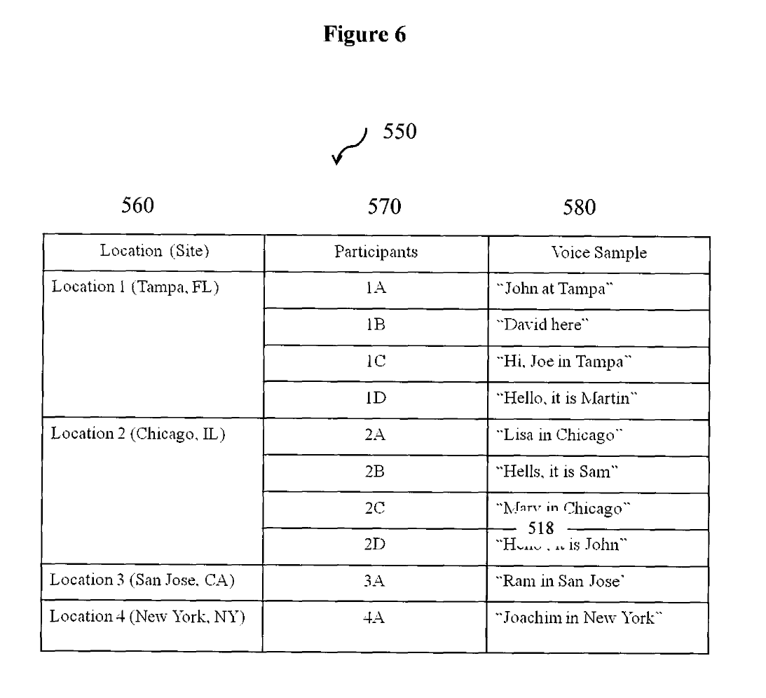

FIG. 6 is a detailed illustration of a sample table 550 prepared by initialization module 324 and stored in database module 325 within the memory unit 321 housed in the voice analysis unit 240. It should be noted that in this embodiment, the table 409 as shown in FIG. 4 is equivalent to the table 550 as shown in FIG. 6.

The initialization module 324 prepares a template for the table 550 as shown FIG. 6 and fills in certain boxes in the table 550 based on the information in the meeting request circulated in advance of the teleconference. For Example, based on the participant's work location, it is possible to fill-in the location information in the boxes under the column 560 in the table 550 as shown in FIG. 6. Thus the Location 1 through Location 4 can be identified and filled in by the initialization module 324 in advance of the teleconference. Similarly the participant information in the boxes under the column 570 in the Table 550 as shown in FIG. 6 can also be filled in by the initialization module 324 even before starting the teleconference. During the roll call process, the already filled in participant information can be verified. For instance, the initialization module 324 may use adaptive speech recognition software to convert the names the participants uttered during the roll call into a textual name and verify the name already in one of the boxes under column 570 in the Table 550 in FIG. 6. If the textual name obtained from adaptive speech recognition software does not match with any of the participants name already there under column 570 or under the circumstance where a participant is joining at the last minute, a new row will be inserted in the Table 550 to include the newly joined participant. A variety of other techniques for identifying the current participants in the meeting will be readily suggested to those skilled in the art. In particular embodiments, the moderator of the teleconference call is allowed to override the obvious errors created by the adaptive speech recognition software with reference to participant ID 407 as shown FIG. 4. Once the recorder 404 as shown FIG. 4 receives the voice samples for each participant, the boxes under column 580 in Table 550 in FIG. 6 are filled in through a hyperlink to the voice samples stored in the recorder 404. as shown in FIG. 4. The voice profile information under the column may include any of variety of voice characteristics. For example, voice profile information column 580 may contain information regarding the frequency characteristics of the associated participant's voice. By comparing the frequency characteristics of the audible sounds represented by the data in the audio signal received from the communication network, the analyzer unit can determine whether any of the voice profile information in column 580 corresponds to the data.

As illustrated in FIG. 2, all three functional units within voice analysis module 240 namely memory unit 321, analyzer unit 322 and processor unit 323 receive audio signal. During the roll call phase, memory unit 321 is active while the analyzer unit 322 and processor unit 323 units are in a dormant state. Once the roll call is over and Table 409 as shown in FIG. 4 is complete, the analyzer unit 322 starts its function of identifying the speaker in the teleconference based on the audible sounds received from Codec 302. When the analyzer unit 322 receives an audio signal from a speaker, it goes through the voice recording stored in the database module 325 within the memory 321 and looks for a matching voice profile. Once a matching voice is identified, the analyzer unit 322 reviews the table 409 and establishes the identity of the speaker and sends that information about the identity of the speaker to the processor unit 323.

When a participant joins the teleconference after the roll call, the memory unit would not have an opportunity to capture the voice profile of that particular speaker and as a result, the analyzer unit 322 could not find a corresponding match for that particular speaker in the database module 325. Under that circumstance, the analyzer 322 may update the voice profile within the database module identifying the speaker as “unidentified X” or “unidentified Y” participant.

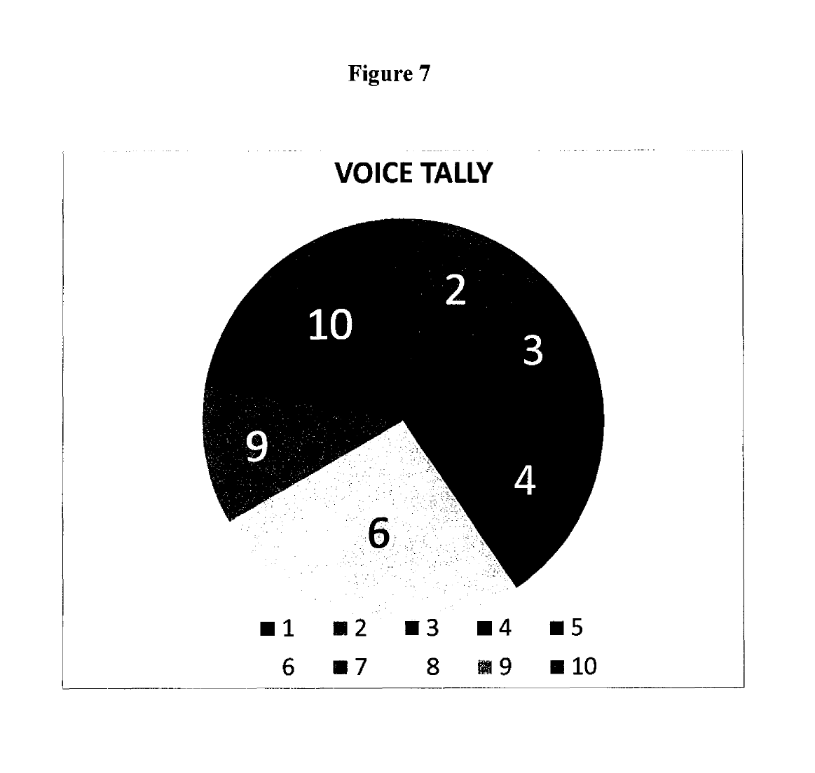

Immediately after roll call is over, parallel to the analyzer unit 322, the processor unit 323 also becomes active and starts receiving audio signal from the speaker. Processor unit 323 starts tagging the audio signal of a speaker as soon the speaker starts speaking and ends the tagging as soon as the speaker stops speaking. As the teleconference progresses, the processor unit 323 starts building two different tables (Table 1 and Table 2). Table 1 contains the detail about the time spent by each participant in a teleconference. In the teleconference example provided in Table, there were ten attendees and four of the attendees (1, 5, 7 and 8) did not participate at all in the discussion. Table 1 provides the start time, end time and total time spent by a participant in a single voice segment recorded for that particular participant. Using the data collected in the Table 1, a voice tally is generated in Table 2. Table 2 provides the total time spent by each participant and also the voice tally for each of the ten participants in the teleconference. FIG. 7 displays the voice tally from the Table 2 as a pie chart.

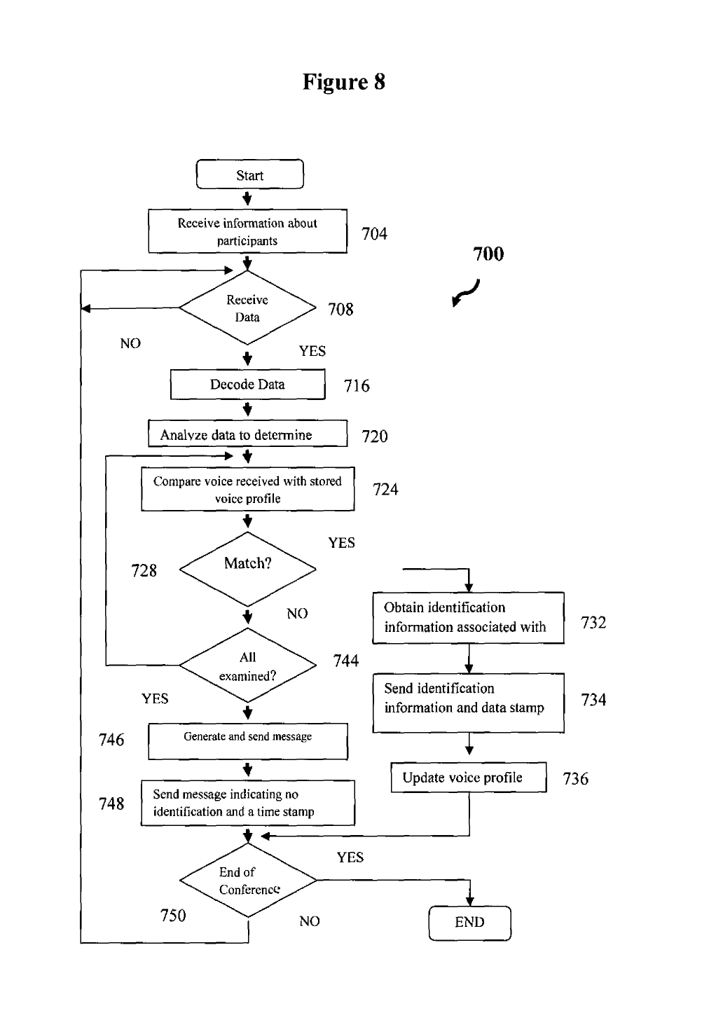

FIG. 8 is a flow chart 700 illustrating a method for identifying a participant during a conference call in accordance with one embodiment of the present invention. In specific embodiment, this method may be implemented by the analyzer unit 322 within voice analysis module 240 as in FIG. 2. At function block 704, the method calls for identification information and voice profile information regarding the participants in a meeting. This may be accomplished by requesting the information from database module 325 within memory unit 321 located inside the voice analysis module 240 as in FIG. 2. At the functional unit 708, the audio data from a speaking participant in the meeting is received contemporaneously. The audio data received from the speaking participant at the functional block 708 is decoded at the functional block 716. The decoded data is analyzed at the functional block 720 and subsequently compared with the stored voice profile stored in the database module. The comparison of the audio data form speaking participant with the stored voice profile is carried out in the functional block 724. At functional block 728 a decision is made whether there is a correspondence between the stored voice profile and the incoming audio signal from the speaker. If no correspondence is established between the incoming audio signal from the speaking participant and any of the stored voice profile, it is sent back to functional block 724. However, if there is a correspondence between the incoming audio signal from a speaking participant and one of the stored voice profile, the incoming audio signal is sent to the functional block 732 and further details about the identification of the corresponding voice profile is obtained. At functional block 734, the audio signal from the speaking participant is associated with the detailed information about the corresponding stored voice profile and sent to the analyzer unit 324 with a data stamp. At functional block 736, using the information gathered at the functional block 734, the voice profile stored in the database module 325 is updated. This process is repeated with the audio signal from the next speaking participant and the second participant is identified. This entire cycle continues till the end of the meeting and in this way all the speakers in a meeting are identified and the total duration of their participation is computed and a simple voice tally is obtained and displayed.

The flowchart 700 can be modified in several different ways by one of skilled in the art for the purpose of identifying the person who is speaking in a meeting. For example, the method might not require the step of decoding incoming audio signal if the comparison between the incoming audio signal and stored voice profile can be established using the incoming coded audio signal alone. A variety of other operations and arrangements will be readily suggested to those skilled in the art.

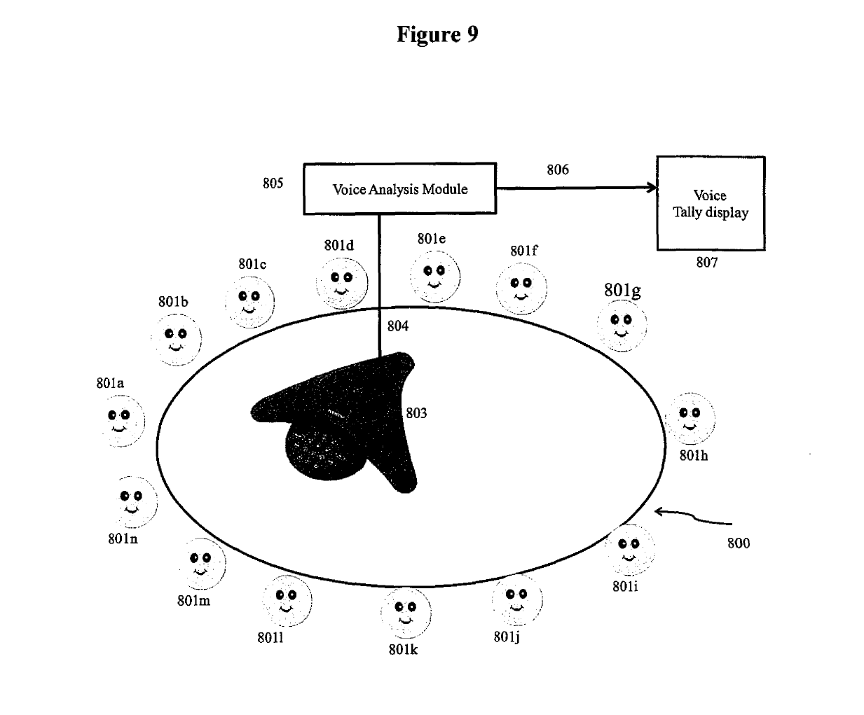

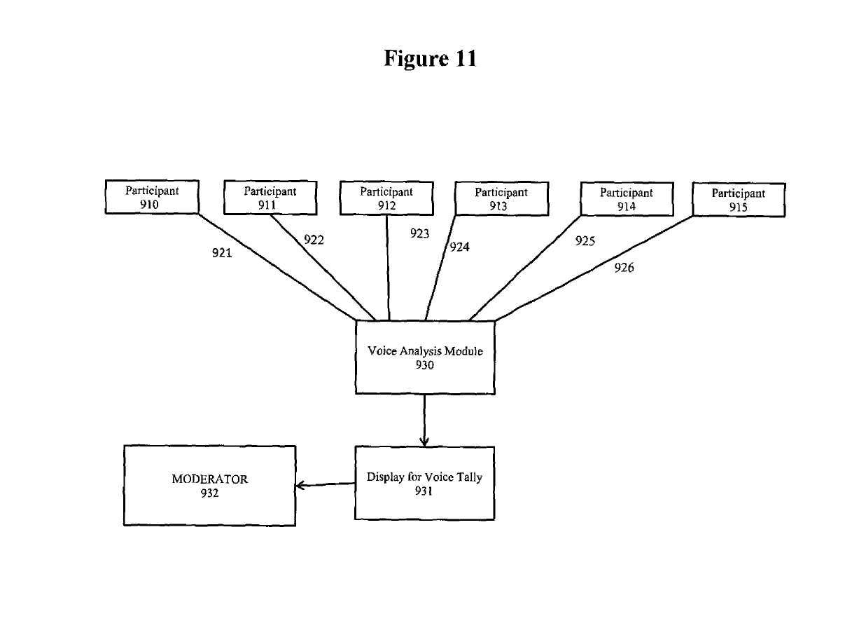

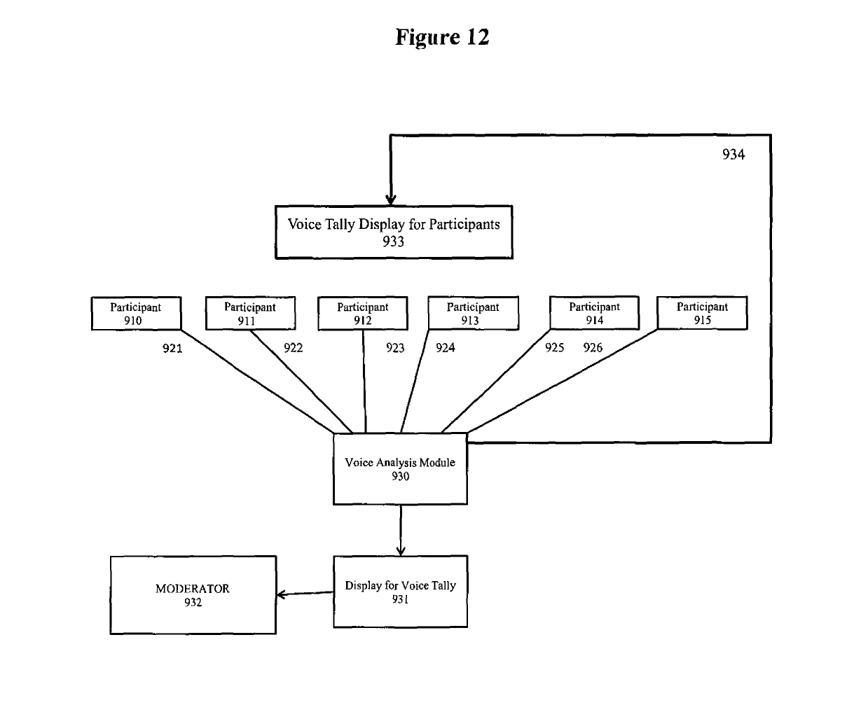

In another embodiment, as illustrated in the FIG. 9, the meeting among plurality of participants occurs in a single location. The participants 801a-801n are seated around a table 800. Situated in the middle of the table 800 is a voice recording equipment such as a PolyCom 803. The PolyCom is connected to a voice analysis module 805 through a wired connection 804. As explained in the embodiment above under FIG. 2, the voice analysis module 240 has a memory unit 321, an analyzer unit 322 and a processor unit 323 and is capable of capturing and analyzing the voice samples from each participant around the table 800 and providing voice tally for each participant on the voice tally display 807 either during the meeting or at the end of the meeting. In this illustrated embodiment, there is wired connection 806 between the voice analysis module 805 and the voice tally table 807. It is also possible to have a wireless connection between the voice analysis module 805 and the voice tally table 807. The access to the voice tally display may be restricted only to the moderator of the meeting shown in FIG. 11 or the access to the voice display may be given to all the participants in the meeting as shown in FIG. 12. FIG. 11, illustrates an embodiment of the present invention, where only the moderator 932 has access to the display for voice tally 931 while the participants 910-915, all situated at the same location, do not have any access to the display to voice tally. FIG. 12 illustrates an another embodiment of the present invention, where the moderator 932 as well as the participants 910-915, all situated at the same location, have access to the display for voice tally 931.

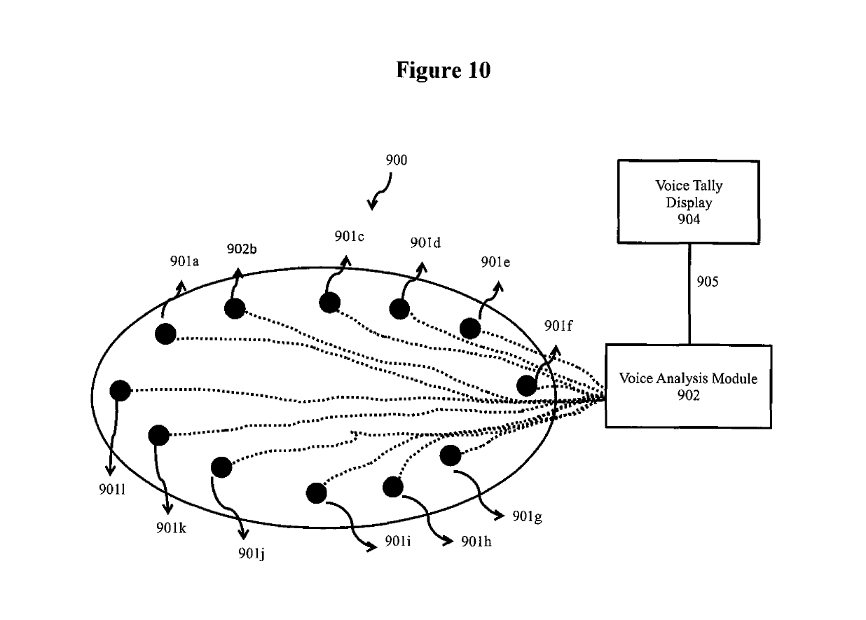

In another aspect of the present invention, as illustrated in FIG. 10, there may be multiple microphones 901a-901l distributed around the table 900. Participants are seated around the table 900 and each participant is assigned an individual microphone. All the microphones are connected to a voice analysis module 902 through individual wired connections. The voice analysis module 902 is connected to a voice tally display 904 using a wired connection 905. In one aspect of this embodiment, the voice analysis module contains three different functional components namely memory unit, analyzer unit and processor unit as described in FIG. 2 above and voice signal from each of the participant is identified based on the voice sample for each of the participants stored in the memory unit. At the beginning of the meeting there is a roll call and the voice sample is obtained and stored in the memory unit of the voice analysis module. If all the participants have attended the meeting earlier and if the memory unit has already received and stored the voice sample, the roll-call step can be skipped.

In another aspect of the present embodiment as illustrated in the FIG. 10 the voice analysis module 902 has a very simple functional configuration and contains only the processor unit. The processor unit identifies each participant based on the physical location of the microphone with which the participant is associated. Thus in this aspect of this embodiment, there is no need for storing the voice sample of each participant to identify the speaking participant at any time during the meeting. The processor unit tags the audio signal from each of the microphones 901a-901l during the entire period of the meeting and generates a voice tally for the participant associated with each microphone. At the beginning of the meeting, the meeting moderator may enter the names of each participant into the computer associated with the voice analysis module so that the voice tally is displayed on the basis of each participant in the meeting rather than on the basis of the identity of the microphones receiving the voice signal from individual participants.

The voice tally obtained for each of the participants in a conference call can be used in a variety of ways. In one aspect of the present invention, the moderator of the teleconference has access to the voice tally display. The moderator may also possess a list of subject matter experts participating in the teleconference. When certain required subject matter expert is not participating in the teleconference where the input of that subject matter expert is very much required, the moderator may prompt that particular subject matter expert to get involved in the ongoing discussion and contribute to the desired outcome of the teleconference. In case the required subject matter expert might have put the audio equipment in mute as evidenced by voice tally, the moderator of the teleconference may have a provision to demute the audio equipment in front of the non-participating subject matter expert besides sending a prompt to that particular attendee.

The capabilities of the present invention can be implemented in software, firmware, hardware and or some combinations thereof. Software as defined in the present invention is a program application that the user installs into a computing device in order to do things like word processing or internet browsing. Software is an ordered sequence of instructions for changing the state of the computer hardware in a particular sequence. It is usually written in high-level programming languages that are easier and more efficient for humans to use. The users can add and delete software whenever they want. Firmware as defined in the present invention is a software that is programmed into chips and usually perform basic instructions for various components like network cards. Thus firmware is software that the manufacturers put into sub-parts of the computing device to give each piece the instruction that it needs to run. Hardware as defined in the present invention is a device that is physically connected to the computing device. It is the physical part of a computing device as distinguished from the computer software that executes within the hardware.

The voice tallying system according to the present invention can be customized for use in a specified location as in the examples provided below. In other words, various components of a voice tally system according to the present invention such a microphone, voice analysis module, memory unit comprising initialization module and database module, analyzer unit comprising identification module, processor unit comprising teleconference log and voice tally unit and voice tally display can be assembled by a person skilled in the art at specific location with commercially available components and used as a stand-alone system. In one aspect of the present invention, the voice tallying system of the present invention can be a part of a web application. In yet another aspect of the present invention, the voice tallying system of the present invention can be made an integral part of any commercially available teleconference equipment/service or can be attached to such commercially available teleconference equipment/service as an auxiliary. In yet another aspect of the present invention, the voice tallying system of the present invention can be made as a part of hand-held mobile smart phone.

A person skilled in the art will be useful to assemble the system for voice tallying according to the present invention by means of developing his or her own software and using it with the commercial available off-the shelf hardware components. Alternately, it is possible to assemble the voice tallying system according to the present invention using off-the shelf hardware components and licensing speaker recognition algorithm from commercial sources. For example, a speaker recognition algorithm named VeriSpeak SDK (Software Developer Kit) is available from Neurotechnology (Vilnius, Lithuania). GoVivace Inc. (McLean, Va., USA) offers a Speaker Identification solution powered by a voice biometrics technology with the capacity to rapidly match a voice sample with thousands, even millions, of voice recordings. GoVivace's Speaker Identification technology is also available as an engine. GoVivace provide customers with a Software Developer Kit (SDK) library as well as a Simple Object Access Protocol (SOAP) and representational state transfer (REST) Application Programming Interfaces (APIs) for developers, even those working on cloud-based applications. When a user of GoVivace Speaker Identification solution provides the software with the voice to be matched, it returns voices from the available recordings that come close to matching the target set. Similarly a person skilled in the art of speech research, with the disclosures in the instant patent application, will be able to build a voice tallying system of the present invention by means of customizing commercially available technologies such as Voice Biometrics from Nuance Communications, Inc. (Burlington, Mass., USA).

One or more aspects of the present invention can be incorporated into an article of manufacture such as a computer useable media. The article of manufacture can be included as a part of a computer system or sold separately. The computer readable media has embodied therein computer readable program code means for providing and facilitating the capabilities of the present invention.

The embodiments described above have been provided only for the purpose of illustrating the present invention and should not be treated as limiting the scope of the present invention. The flow diagrams depicted herein are just examples. There may be many variations to these diagrams or the steps or operations described therein without departing from the spirit of the invention. Numerous modifications of the embodiments described herein may be readily suggested to one of skilled in the art without departing from the scope of the appended claims. For further clarification, the illustrative embodiments of the present invention are presented as comprising individual functional blocks. The functions these blocks perform may be provided through the use of either shared or dedicated hardware, including, but not limited to, hardware capable of executing software. It is intended, therefore, that the appended claims encompass such modifications to the embodiments disclosed herein.

### REFERENCES

All references are listed for the convenience of the reader. Each reference is incorporated by reference in its entirety.
U.S. Pat. No. 3,496,465
U.S. Pat. No. 3,535,454
U.S. Pat. No. 3,832,493
U.S. Pat. No. 4,081,605
U.S. Pat. No. 4,295,008
U.S. Pat. No. 4,377,961
U.S. Pat. No. 4,424,415
U.S. Pat. No. 4,441,202
U.S. Pat. No. 4,809,332
U.S. Pat. No. 4,833,714
U.S. Pat. No. 4,882,758
U.S. Pat. No. 4,914,702
U.S. Pat. No. 4,941,178
U.S. Pat. No. 5,146,539
U.S. Pat. No. 5,214,708
U.S. Pat. No. 5,321,350
U.S. Pat. No. 5,450,481
U.S. Pat. No. 5,463,716
U.S. Pat. No. 5,528,670
U.S. Pat. No. 5,574,823
U.S. Pat. No. 5,577,160
U.S. Pat. No. 5,668,863
U.S. Pat. No. 5,787,387
U.S. Pat. No. 5,893,902
U.S. Pat. No. 6,026,357
U.S. Pat. No. 6,067,511
U.S. Pat. No. 6,078,879
U.S. Pat. No. 6,324,505
U.S. Pat. No. 6,424,937
U.S. Pat. No. 6,505,152
U.S. Pat. No. 6,738,739
U.S. Pat. No. 6,741,960
U.S. Pat. No. 6,853,716
U.S. Pat. No. 6,898,568
U.S. Pat. No. 6,952,676
U.S. Pat. No. 6,983,241
U.S. Pat. No. 7,027,980
U.S. Pat. No. 7,047,200
U.S. Pat. No. 7,076,073
U.S. Pat. No. 7,099,448
U.S. Pat. No. 7,185,054
U.S. Pat. No. 7,139,705
U.S. Pat. No. 7,266,189
U.S. Pat. No. 7,305,078
U.S. Pat. No. 7,337,107
U.S. Pat. No. 7,424,423
U.S. Pat. No. 7,340,397
U.S. Pat. No. 7,386,448
U.S. Pat. No. 7,424,423
U.S. Pat. No. 7,490,038
U.S. Pat. No. 7,516,067
U.S. Pat. No. 7,521,622
U.S. Pat. No. 7,567,900
U.S. Pat. No. 7,668,304
U.S. Pat. No. 7,756,700
U.S. Pat. No. 7,756,703
U.S. Pat. No. 7,778,825
U.S. Pat. No. 7,818,169
U.S. Pat. No. 7,844,454
U.S. Pat. No. 7,899,699
U.S. Pat. No. 7,979,270
U.S. Pat. No. 8,060,368
U.S. Pat. No. 8,065,140
U.S. Pat. No. 8,099,290
U.S. Pat. No. 8,161,110
U.S. Pat. No. 8,195,461
U.S. Pat. No. 8,200,478
U.S. Pat. No. 8,265,341
U.S. Pat. No. 8,406,403
U.S. Pat. No. 8,515,747
U.S. Pat. No. 8,542,812
U.S. Pat. No. 8,548,806
U.S. Pat. No. 8,542,812
U.S. Pat. No. 8,554,546
U.S. Pat. No. 8,558,864
U.S. Pat. No. 8,558,865
U.S. Pat. No. 8,649,494
U.S. Pat. No. 8,660,251
U.S. Pat. No. 9,076,444
U.S. Pat. No. 9,076,448
U.S. Patent Application Publication No. US2009/0006608
U.S. Patent Application Publication No. US2011/0238361
U.S. Patent Application Publication No. US 2012/0089396
U.S. Patent Application Publication No. US2012/0327193
International Patent Application Publication No. WO2003/098373A2
Anguera, X., Bozonnet, S., Evans, N., Fredouille, C., Friedland, G. and Vinyals, O. (2010) Speaker Diarization: A review of recent research. IEEE Transactions on 20(2): 356-370.
Atal, B. S., and Hanauer, L. S. (1971) Speech analysis and synthesis by linear prediction of the speech wave. J. Acoust. So. Am. 50: 637-655.
Campbell, J R., J. P. (1997) Speaker Recognition: A tutorial. Proceedings of the IEEE 85(9), 1437-1462.
Davis, S. B. and Mermelstein, P. (1980) Comparison of parametric representation for monosyllabic word recognition in continuously spoken sentences. IEEE Trans. Acoust. Speech Sig. Process. 28(4) 357-366.
Do, C-T., Barras, C., Le, V-B. and Sarkar, A. K. (2013) Augmenting short-term cepstral features with long term discriminative featured for speaker verification of telephone data. 13: 25-29.
Ehkan, P., Zakaria, F. F., Warip, M. N. M., Sauli, Z. and Elshaikh, M. (2015) Advanced Computer and Communication Engineering Technology. Springer International Publishing. pp 471-480.
Ganapathy, S., Thomas, S. and Hynek Hermansky, H. (2012) Feature extraction using 2-D autoregressive models for speaker recognition. ISCA Speaker Odyssey De Krom, G. (1993) A cepstrum-based techniques for determining a harmonics-to-noise ratio in speech signals. Journal of Speech and Hearing Research. 36: 254-266.
Heremansky, H. (1990) Perpetual liner predictive analysis of speech. J. Acoust. Soc. Am. 87(4):1738-1752.
Hillenbrand, J., Clevland, R. A., and Erickson, R. L. (1994) Acoustic correlates of breathy vocal quality. Journal of Speech and Hearing Research 37: 769-778.
Hillenbrand, J. and Houde, R. A. (1996) Acoustic correlates of breathy vocal quality: Dysphonic voices and continuous speech. Journal of Speech and Hearing Research 39: 311-321.
Iseli, M., Shue, Y-L. and Alwan, A. (2007) Age, sex, and vowel dependence of acoustic measures related to the voice source. Journal of Acoustic Society of America 121: 2283-2295.
Itakura, F. (1975) Minimum prediction residual principle applied to speech recognition. IEEE Transactions—Acoustic Speech Signal Processing. 23, 67-72.
Kato, H. and Kawahara, Hideki, K. (1998) An application of the Bayesian time series model and statistical system analysis for F0 control. Speech Communication 24: 325-339.
Kinnunen, T. and Li, H. (2010) An overview of text-independent speaker recognition: from features to super vectors. Speech Communication 52(1): 12-40.
Kotti, M., Moschou, V. and Kotropoulos, C. (2008) Speaker segmentation and clustering. Signal Processing, 88(5): 1091-1124.
Leu, J-G., ZGeeng, L-t., Pu. C. E. and Shiau, J-B. (2011) Speaker Verification based on comparing normalized spectrograms. Security Technology (ICCST), IEEE International Carnahan Conference on, pp 1-5.
Mallidin, S. H., Ganapahty, S. and Hermansky, H. (2013) Robust speaker recognition using spectra-temporal autoregressive models. Interspeech pp 3689-3693.
Peacocke, R. D. and Graf, D. H. (1990) An introduction to speech and speaker recognition. Computer 23(8): 26-33.
Reynolds, D. A. and Rose, R. C. (1995) Robust text-independent speaker identification using Gaussian mixture models. IEEE Transactions on Speech and Audio Processing. 3(1): 72-83.

Shue, Y-L., Keating, P., Vicenik, C. and Yu, K. (2011) Voicesauce: A program for voice analysis. Proceedings of the 17^{th} International congress of Phonetic Sciences, 17-21 August, 2011, Hong Kong, pp 1846-1849.

TABLE 1
Monitoring the time spent by ten different participants (1 to
10) in a 15 minute conference call. Participants 1, 5, 7 and
8 were quiet during the entire period of the conference call.

| | Start Time(to) | End Time (tn) | Total Duration |
|---|---|---|---|
| Participant Number | (Minutes) | (Minutes) | (Minutes) |
| 2 | 0.00 | 0.20 | 0.20 |
| 4 | 0.20 | 0.40 | 0.20 |
| 2 | 0.40 | 2.10 | 1.30 |
| 3 | 2.10 | 3.30 | 1.20 |
| 6 | 3.30 | 7.25 | 3.55 |
| 4 | 7.25 | 10.00 | 2.35 |
| 10 | 10.00 | 13.20 | 3.20 |
| 9 | 13.20 | 15.00 | 1.40 |

TABLE 2
Voice tally for participants in a conference call. There
were ten participants (1-10) in the conference call. Total
time (minutes) for spent by each of the participants in
the conference call as well as the relative participation
of each of the participant (voice tally) is provided

| | Total time spent in the | |
|---|---|---|
| Participant number | conference call (minutes) | Voice Tally |
| 1 | 0.0 | 0.00% |
| 2 | 1:50 | 12.22% |
| 3 | 1:20 | 8.89% |
| 4 | 2:55 | 19.44% |
| 5 | 0.0 | 0.00% |
| 6 | 3:55 | 26.11% |
| 7 | 0.0 | 0.00% |
| 8 | 0.0 | 0.00% |
| 9 | 1:40 | 11.11% |
| 10 | 3:20 | 22.22% |

What is claimed:

1. A voice tallying system for conducting ((a)) an effective meeting among plurality of participants wherein equal participation of all the participants is assured comprising:
a. at least one voice recording device for capturing audio signal from plurality of participants;
b. a communication path along which the audio signal from plurality of participants is transmitted to a computing device for calculating relative participation of participants in the meeting; and
c. a device for displaying voice tally for plurality of participants in the meeting.

2. A voice tallying system as in claim 1 wherein said device for displaying voice tally for plurality participants in the meeting is available to a moderator conducting said meeting among plurality of participants.

3. A voice tallying system as in claim 1, wherein said device for displaying voice tally for plurality participants in the meeting is available to each of the plurality of participants.

4. A voice tallying system as in claim 1, wherein said plurality of participants are in one location.

5. A voice tallying system as in claim 1, wherein said plurality of participants are in different locations.

6. A voice tallying system as in claim 1, wherein said computing device comprises a voice analysis module.

7. A voice tallying system as in claim 1, wherein said computing device is a stand-alone device.

8. A voice tallying system as in claim 1, wherein said computing device is incorporated into a desktop computer, a lap top computer, a mainframe computer or a tablet computer.

9. A voice tallying system as in claim 1, wherein said computing device is incorporated into a mobile computer device.

10. A voice tallying system as in claim 1, wherein said computing device is incorporated into a mobile smart phone.

11. A voice tallying system as in claim 1, wherein said recording device has the capacity to capture both video and audio signals from plurality of participants.

12. A method for voice tallying the participation of participants in a meeting to assure equal participation of all the participants, the method comprising the steps of:
a. recording voice sample of each participant before the meeting;
b. continuously monitoring audio signal from each of the participants during the meeting;
c. identifying a speaker during the meeting by comparing audio signal from that speaker with the recorded voice sample from the step (a) and
d. tallying participation of plurality of participants in the meeting.

13. A method for voice tallying the participation of plurality of participants in a meeting as in claim 12, wherein said participants are in a single location.

14. A method for voice tallying the participation of plurality of participants in a meeting as in claim 12, wherein said participants are in multiple locations.

15. A method for voice tallying the participation of plurality of participants in a meeting as in claim 12, wherein said recording of voice sample in step (a) and said identification of speaker in step (c) are carried out by a computing device comprising a voice analysis module.

16. A method for voice tallying the participation of plurality of participants in a meeting as in claim 15, wherein said computing device is a stand-alone device.

17. A method for voice tallying the participation of plurality of participants in a meeting as in claim 15, wherein said computing device is incorporated into a desktop computer, a lap top computer, a mainframe computer or a tablet computer.

18. A method for voice tallying the participation of plurality of participants in a meeting as in claim 15, wherein said computing device is incorporated into a mobile computer device.

19. A method for voice tallying the participation of plurality of participants in a meeting as in claim 15, wherein said computing device is incorporated into a mobile smart phone.

20. A processor-readable medium comprising processor-executable instruction configured for:
a. receiving plurality of first audio inputs from plurality of attendees of the meeting before the meeting;
b. storing said plurality of first audio inputs from said attendees of the meeting in memory along with the identity of each attendees;
c. receiving plurality of second audio inputs from plurality of attendees who spoke at the meeting;
d. conducting voice analysis on each of said second audio inputs from said plurality of attendees who spoke at the meeting and assigning each of said second audio inputs to individual speakers among said plurality of attendees who spoke at the meeting; and
e. providing display of audio signal tally of said plurality of attendees who spoke at the meeting.
